(19) United States
(12) Patent Application Publication
(10) Pub. No.: US 2012/0116957 A1
(43) Pub. Date: May 10, 2012

(54) SYSTEM AND METHOD FOR POPULATING A LIST OF TRANSACTION PARTICIPANTS

(75) Inventors: Mark D. Zanzot, Charlotte, NC (US); Charmaine Klein, Charlotte, NC (US); Jon R. Wolf, Charlotte, NC (US); Donna Patel, Charlotte, NC (US)

(73) Assignee: Bank of America Corporation, Charlotte, NC (US)

(21) Appl. No.: 13/230,530

(22) Filed: Sep. 12, 2011

Related U.S. Application Data
(60) Provisional application No. 61/507,879, filed on Jul. 14, 2011.
(60) Provisional application No. 61/410,085, filed on Nov. 4, 2010.
(60) Provisional application No. 61/410,087, filed on Nov. 4, 2010.

(51) Int. Cl. G06Q 40/00

(52) U.S. Cl. 705/39

(57) ABSTRACT

Embodiments of the invention provide a method of populating a list of transaction participants with the aliases of individuals and entities that can participate in P2P transactions. In some embodiments, the list of transaction participants is a list of payment recipients to whom the user can make P2P payments and the list is populated with a third party's alias. In other embodiments, the list of transaction participants in a list of recipients to whom a third party can make P2P payments and the list is populated with the user's alias. In some embodiments, a method is provided that includes: (1) receiving information associated with a party to a financial transaction with a user; (2) determining, at least partially on the information associated with the party, that the party can participate in a P2P transaction with the user; and (3) populating a list of P2P transaction participants with an alias identifier.

### CROSS-REFERENCE TO RELATED APPLICATIONS

This application claims priority to the following applications: U.S. Provisional Patent Application Ser. No. 61/507,879, filed Jul. 14, 2011; U.S. Provisional Patent Application No. 61/410,085, filed on Nov. 4, 2010; and U.S. Provisional Patent Application No. 61/410,087, filed on Nov. 4, 2010, and as such, herein incorporates these applications by reference.

Furthermore, embodiments of the invention include and build off of the following applications sharing a common assignee with the present application: U.S. Design Patent Application Ser. No. 29/378,420, filed on Nov. 4, 2010; and U.S. Design Patent Application Ser. No. 29/378,418, filed on Nov. 4, 2010, and as such, herein incorporates these applications by reference.

### BACKGROUND

With the wide adoption of credits cards, debit cards, electronic payment devices, online shopping systems, and online banking systems, very few people today carry a lot of cash or write many checks. However, people still need to transfer money to each other for all sorts of reasons. For example, a person may want to pay a friend back for money recently borrowed from the friend, or a person may want to send money to a relative as a gift. Giving or lending money to another person, however, can be difficult when you don't have cash on hand and/or if the person is not physically present. The process may need to involve going to an automated teller machine (ATM) or mailing the person a check, both of which can be time consuming and inconvenient depending on the situation.

Money can be transferred from one person to another using electronic banking systems, but these systems traditionally require that the sender know account information for the receiver in order to instruct the bank to transfer money to the proper account. Most people do not know the account numbers of their friends, nor do most people want to widely publicize their account numbers for security reasons.

Some third party service providers try to facilitate payments from one person to another, but many people do not like these systems because they require opening yet another account with another online entity, remembering yet another username and password, and disclosing confidential financial institution account information to these other companies. In addition to the inconvenience and the security concerns, these systems generally take time to set up and are not user-friendly.

For all these reasons and others, there is a need for improved user-friendly systems and methods for transferring money between two people and/or other entities, especially if such systems can transfer money directly to and/or from financial institution accounts, such as demand deposit accounts (e.g., checking accounts), savings accounts, and/or credit accounts.

### BRIEF SUMMARY

Embodiments of the invention relate to apparatuses, methods, and computer program products that allow a user to populate a list of transaction participants.

In some embodiments of the invention, a computing device: (1) receives information associated with a party to a financial transaction with the user; (2) determines based at least partially on the information, that the party can participate in a user-to-user (U2U) transaction (commonly referred to herein as a person-to-person (P2P) transaction) with the user; and (3) populates the list of P2P transaction participants with an alias identifier.

In some embodiments, the receiving information associated with a party to a financial transaction with the user comprises receiving the name of the party. In some other embodiments, the receiving information associated with a party to a financial transaction with the user comprises receiving an indication that the user would like to make a P2P payment to the party. In yet some other embodiments of the invention, the receiving information associated with a party to a financial transaction with the user comprises receiving an indication that the user would like to receive a P2P payment from the party.

In some embodiments, the determining, based at least partially on the information associated with the party, that the party can participate in a P2P transaction with the user comprises comparing the party's name to information about parties that can participate in a P2P transactions with the user.

In some embodiments of the invention, the populating a list of P2P transaction participants with an alias identifier comprises populating a list of P2P payment recipients with an alias identifier. In some embodiments, the populating the list of P2P payment recipients with the alias identifier comprises populating the list of P2P payment recipients with the alias identifier of the party. In other embodiments, the populating the list of P2P payment recipients with the alias identifier comprises populating the list of P2P payment recipients with the alias identifier of the user. In still some other embodiments, the populating a list of P2P transaction participants with an alias identifier comprises populating a list of authorized P2P payment senders with the alias identifier of the party.

In some embodiments, the receiving information associated with a party to a financial transaction with a user comprises receiving the information at a computing device associated with the user. In some other embodiments, the receiving the information at the computing device associated with the user comprises receiving the information at a mobile device. In yet some other embodiments, the receiving information associated with a party to a financial transaction with a user comprises receiving the information at a network device in communication with a computing device associated with the user.

In some embodiments, the determining, based at least partially on the information associated with the party, that the party can participate in a P2P transaction with the user comprises making the determination at a computing device associated with the user. In some other embodiments, the determining, based at least partially on the information associated with the party, that the party can participate in a P2P transaction with the user comprises making the determination at a network device in communication with a computing device associated with the user.

In some embodiments, the populating a list of P2P transaction participants with an alias identifier comprises populating a list of P2P transaction participants that is accessible to the user. In some other embodiments, the populating a list of P2P transaction participants with an alias identifier comprises populating a list of P2P transaction participants that is accessible to the party.

The features, functions, and advantages that have been discussed may be achieved independently in various embodiments of the present invention or may be combined with yet other embodiments, further details of which can be seen with reference to the following description and drawings. Additionally, as will be appreciated by one of ordinary skill in the art, the features, functions, and advantages that have been discussed may include and/or be embodied as an apparatus (including, for example, a system, machine, device, computer program product, and/or the like), as a method (including, for example, a business method, computer-implemented process, and/or the like), or as any combination of the foregoing.

### BRIEF DESCRIPTION OF THE DRAWINGS

Having thus described embodiments of the invention in general terms, reference will now be made the accompanying drawings, wherein:

FIG. 1 is a combination flowchart and block diagram of a system and method for making P2P payments, in accordance with example embodiment of the invention;

FIG. 2 is a block diagram illustrating the various ways through which a customer may make P2P payments, in accordance with various embodiments of the invention;

FIG. 3 provides a block diagram illustrating an P2P payment system and environment, in accordance with an embodiment of the invention;

FIG. 4 provides a block diagram illustrating the first user's personal computing device of FIG. 3, in accordance with an embodiment of the invention;

FIG. 5 provides a block diagram illustrating the second user's personal computing device of FIG. 3, in accordance with an embodiment of the invention;

FIG. 6 provides a block diagram illustrating a mobile device that in some embodiments of the invention may be the first user's personal computing device and/or second user's personal computing device of FIG. 3

FIG. 7 provides a block diagram illustrating the financial institution's banking system of FIG. 3, in accordance with an embodiment of the invention;

FIG. 8 provides a block diagram illustrating the alias data repository of FIG. 3, in accordance with an embodiment of the invention;

FIG. 9 is a flow diagram illustrating a general process flow for populating a list of P2P transaction participants.

FIG. 10 is a flow diagram illustrating a more-detailed process flow of an embodiment for populating a list of P2P transaction participants.

FIG. 11 is a flow diagram illustrating a more-detailed process flow of an embodiment for populating a list of P2P transaction participants.

### DETAILED DESCRIPTION OF EMBODIMENTS OF THE INVENTION

Embodiments of the present invention will now be described more fully hereinafter with reference to the accompanying drawings, in which some, but not all, embodiments of the invention are shown. Indeed, the invention may be embodied in many different forms and should not be construed as limited to the embodiments set forth herein; rather, these embodiments are provided so that this disclosure will satisfy applicable legal requirements. Where possible, any terms expressed in the singular form herein are meant to also include the plural form and vice versa, unless explicitly stated otherwise. Also, as used herein, the term “a” and/or “an” shall mean “one or more,” even though the phrase “one or more” is also used herein. Furthermore, when it is said herein that something is “based on” something else, it may be based on one or more other things as well. In other words, unless expressly indicated otherwise, as used herein “based on” means “based at least in part on” or “based at least partially on.” Like numbers refer to like elements throughout.

In accordance with embodiments of the invention, the terms “financial institution” and “financial entity” include any organization that processes financial transactions including, but not limited to, banks, credit unions, savings and loan associations, investment companies, stock brokerages, asset management firms, insurance companies and the like. In specific embodiments of the invention, use of the term “bank” is limited to a financial entity in which account-bearing customers conduct financial transactions, such as account deposits, withdrawals, transfers and the like.

### Method for P2P Payments

Embodiments of the present invention provide a system and method for banking integrated user-to-user (U2U) payments. Such banking integrated U2U payments may be made online through an online banking website or via a mobile banking application or U2U payment application. Embodiments of the invention allow customers of a financial entity to make payments directly from their accounts, whether their accounts be checking, savings, line of credit, credit card, and/or other accounts, to a payment or transfer recipient, including financial entity customers and non-financial entity customers, without having to share any confidential account information and without having to know account information for the intended payment recipient. Embodiments of the invention also allow customers and non-customers to receive payments from others directly into their financial institution accounts without requiring the customer to share account information with the payment sender. It should be noted that some embodiments of the invention allow a customer to make payments to and/or receive payments from a merchant in the same way that a customer can make payments to and/or receive payments from another person. In an effort to ensure breadth of claims, the term user-to-user (U2U) is used in the claims. Person-to-person (P2P) is a term generally known in the art to mean any type of user to any type of user. As such, as used herein, the phrases person-to-person (P2P) and user-to-user (U2U) are each intended to include person-to-person (P2P), person-to-merchant (P2M), merchant-to-merchant (M2M), and merchant-to-person (M2P) unless specifically stated otherwise. The phrases person-to-person (P2P) and user-to-user (U2U) are also each intended to include transactions involving entities that are not merchants, such as non-profit entities, foundations, and/or other organizations unless specifically stated otherwise. Embodiments of the present invention permit a sender to send money from the sender's financial institution account directly to the recipient's financial institution account using the alias of the recipient without the involvement of an intermediary or a third party. This allows for greater security as no party apart from the sender, the recipient, and the bank is ever a part of the transfer.

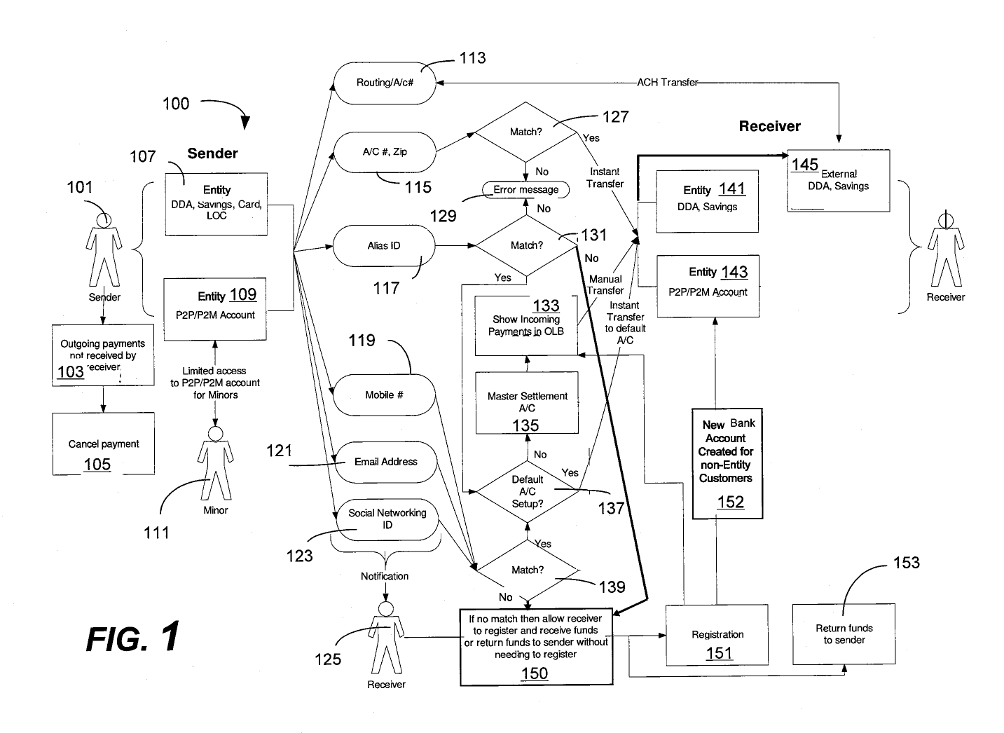

FIG. 1 is a combination block diagram and flowchart providing an overview of a system and method 100 for making P2P payments, in accordance with one or more embodiments of the invention. A customer 101 (also referred to as sender 101) with an eligible account 107, e.g., checking (demand deposit account or “DDA”), savings, money market, line of credit, credit card, etc., of a financial entity is be able to register and make use of this service. During the registration process, the customer 101 is able to set up an alias identifier (ID) 117 (or simply an “alias”) (as used herein, the terms “alias”, “alias identifier”, and “alias ID” shall have the same meaning) that maps back to the customer's financial institution account. The alias 117 may be a personal name, nickname, company name, trademark, logo, brand, graphical art, or any unique identifier (including without limitation any text or image) other than an account number. Typically, the alias 117 is an identifier that friends, family, and/or other members of the public uniquely associate with the customer 101. For example, the alias 117 may be a mobile telephone number 119, an email address 121, a social networking ID 123, and/or the like. The embodiments of the invention described herein in the other figures generally permit the customer 101 to use either a mobile telephone number 119 or an email address 121 as the account alias, but it will be appreciated that, in view of this disclosure, other embodiments of the invention may allow use of other types of aliases.

The information provided by the customer 101 during registration of an alias may be verified to confirm that the customer 101 does have access to the mobile number 119, email address 121, social networking ID 123, or other alias 117 provided. For example, as described in greater detail below, the financial institution (or other entity that maintains a database of aliases and associates them with financial institution accounts) may send a communication to the customer 101 using the alias and require the customer 101 to confirm access to the alias by responding to the notice in some way. For example, if the alias registered by the customer 101 is a mobile telephone number 119, the financial institution may send a text message to the mobile telephone number 119 with a code and then require that the customer 101 enter the code into a mobile banking or online banking application to confirm that the mobile telephone number is associated with the customer 101. Once the alias information is verified, then the alias is linked to one or more of the customer's financial institution accounts in a data repository maintained by the financial institution or some other entity that provides an alias registry service to the financial institution.

The customer 101 can also use embodiments of the invention to make payments to other entities, such as receiver 125, using an alias of the receiver 125. In some embodiments, receiver 125 may be another person and in other embodiments, receiver 125 may be a merchant. In some embodiments of the invention, the customer 101 is able to set preferences for accounts to be used for outgoing payments, and default account(s) for incoming payments. In some embodiments of the invention, the financial institution places limits (e.g., maximums and/or minimums) on how much money can be sent or received using P2P payment aliases, and such limits may be based on the sender, the receiver, whether the receiver is a customer of the financial institution or a partner financial institution, account history, credit ratings, customer status, whether the customer has registered the alias, and/or any other relevant information. In some embodiments, the customer 101 can also establish limits on P2P payments. For example, a customer 101 may want to set a maximum of $1000 for P2P payments where an alias is used for the recipient as opposed to an account number.

In some embodiments of the invention, the customer 101 may also have an option of opening a new P2P account 109 with the financial institution that the customer may use exclusively for making and/or receiving P2P payments. This financial entity P2P account 109 may be like any other account hosted at the financial entity and so money may be moved instantly into this account 109 through the regular banking transfer process for moving money between a customer's accounts. This account 109 may be a type of checking account except that it may come with certain limitations, e.g., no checks, maximum balance limits, number of daily transactions or the like, and may be opened by customers by providing much less information as compared to a regular checking account. The financial entity may, at a minimum, require customers to provide certain information, such as name, address, date of birth, and social security number, in order to comply with Anti-Money Laundering (AML) regulations. Customers 101 of the financial entity may also have an option to set up P2P accounts 109 (i.e., sub-accounts) for minors 111, other dependents, or related entities. Customers 101 are able to access these accounts just like any of their other accounts. In addition, customers 101 are able to set up a banking access ID for the minor 111 that the minor 111 may use to sign into online and/or mobile banking but have access only to the specific minor P2P account 109 set up for them. These P2P-specific accounts and sub-accounts are described in more detail in U.S. patent application Ser. No. 12/038,177 filed on Feb. 27, 2008 and entitled “Sub-Account Mechanism,” which application was assigned to, or subject to an obligation to assign to, the same assignee of the present application at the time of filing of the present application and at the time of conception of the inventions described herein.

Referring again to FIG. 1, customers 101 of the financial entity are able to make payments to other people or merchants through any of a number of different methods. Payments may be made by a routing number/account number 113. Payments may also be made by providing an account number and an additional identifier, such as a zip code 115. If there is a match to an existing financial entity account in block 127, then the funds are transferred instantly to that account. Else, an error message 129 may be generated.

In accordance with embodiments of the invention, payments may be made by using an alias 117 maps to a recipient's financial institution account. As previously discussed, the alias 117 may be a personal name, nickname, company name, trademark, logo, brand, graphical art, or any unique identifier (including without limitation any text or image) other than an account number. In some embodiments of the invention, customer 101 may use a keyboard or other input device to type the name of an alias 117 to which customer 101 would like to make a payment. In other embodiments of the invention, the online banking website, mobile banking application, and/or P2P payment application may suggest an alias 117 for customer 101 to use. In yet other embodiments, the online banking website, mobile banking application, and/or P2P payment application may include a list of stored aliases that the customer 101 may use, including an alias 117. In some embodiments of the invention, the online banking website, mobile banking application, and/or P2P payment system automatically suggests that customer 101 add alias 117 to a list of stored aliases based upon the financial transaction history of customer 101. In other embodiments of the invention, the customer 101 may review a list of transactions with other persons, entities, and/or merchants through an online banking website or mobile banking application and indicate the other persons, entities, and/or merchants for which the customer 101 would like to save aliases that could be used in connection with future P2P payments. In yet other embodiments of the invention, the list of P2P payment recipients is automatically pre-populated with at least an alias 117 to whom customer 101 may send a P2P payment.

In general, as described in greater detail below, the customer 101 initiates a P2P payment by using an alias and communicating an alias 117 and an associated payment amount to the financial institution. The financial institution then accesses an alias database, or other type of data repository, to determine if the entered alias 117 has been registered by the alias holder and is, thereby, associated with a particular financial institution account. If the alias 117 does have a match to another customer in block 131 or financial institution account of another customer in block 131, then the payment may be initiated to that person. If there is no match, then either an error message 129 is generated or, if possible, the alias 117 may be used to contact the intended recipient (i.e., receiver 125) and allow this person to register the alias 117 and thereby associate the alias with a financial institution account. At any time, if outgoing payments or payment notifications are not received by a receiver (as represented by block 103), the payment may be canceled (as represented by block 105).

In some embodiments of the invention, an alias 117 may be associated with multiple financial institution accounts of the alias holder. In some such embodiments, the alias holder may be able to establish a default account when registering the alias 117 or afterwards. Consequently, if a receiver 125 does have a default account for incoming payments in block 137, then the funds may be transferred instantly to that account(s). If the receiver 125 has not set up a default account in block 137 but the receiver 125 does have multiple accounts associated with the alias 117, then the funds may be moved to a master settlement account 135 and the receiver 125 may see the payment as an incoming payment within online or mobile banking applications, as described in block 133. The receiver 125 may then be able to use the banking application to move the funds instantly to any of the receiver's others accounts. In other embodiments, however, each alias 117 is associated only with one financial institution account and, therefore, the steps of blocks 137 and 135 are not needed and the payment is deposited directly into the one financial institution account associated with the alias 117.

As further illustrated in FIG. 1, the alias 117 may be a mobile telephone number 119 and, as such, payment may be made by the customer 101 providing a mobile phone number 119 (the mobile telephone number 119 being the mobile telephone number of the intended payment recipient 125) along with an associated payment amount. This operation may perform exactly as described above for the alias 117 if there is a match in block 139 on the mobile number. If there is no match in block 139, then a text message may be sent to the mobile number 119 provided (as represented by block 150). If the receiver 125 of the message is an existing financial institution customer (or, in some embodiments, if the receiver 125 is a customer of a partner financial institution), then that person may be allowed to sign into their online or mobile banking account, register the phone number as illustrated by block 151 (thereby associating the phone number with a financial institution account for P2P payment purposes), and then receive funds similar to the process described above for the alias 117. If the receiver 125 is not a financial entity customer with an account eligible for receiving funds, then the receiver 125 may be given the option to sign up (as represented by block 152) for a financial institution account (as represented by block 141 or 143) at the financial institution or return funds to the sender (as represented by block 153).

As further illustrated in FIG. 1, the alias 117 may be an email address 121 and, as such, payment may be made by the customer 101 providing an email address 121 (the email address 121 being an email address of the intended payment recipient 125) along with an associated payment amount. This operation may perform exactly as described above for a mobile number 119 except that the notification message (with the registration or account opening option if appropriate) is sent to the email address 121 provided.

In some embodiments of the invention, payment may be made by providing a social networking ID 123, such as a unique ID associated with the receiver 125 on a particular social networking Internet site. In such a situation, the process operates in the same way as described above for mobile phone number 119 and email address 121 except the social networking platform may be used to notify the receiver based on the social networking ID 123 provided.

In some embodiments of the invention, payment may be made by providing a routing/account number 113. In such a situation, the process operates in the same way as described above for mobile phone number 119 and email address 121 except the payment is sent via an ACH transfer to an external DDA or savings account 145 at a financial institution that is different than the financial institution associated with customer 101. In such embodiments, contact information stored (such as a mobile number or email address) at or available to the financial institution associated with receiver 125 may be used to notify the receiver 125 of the ACH transfer.

In all cases described above, if the receiver 125 is already a customer of the financial institution or a partner financial institution and has already registered the alias 117 provided by the sender 101, a text message, email, mobile banking notice, online banking notice, or other type of message may be sent to receiver 125 based on the alias 117 or irrespective of any information entered or selected by sender if there is other contact information found in the receiver's profile, the notification notifying the receiver 125 of the payment. In some embodiments, the receiver 125 may be allowed to reject or re-route the payment and/or provide other information about how payments from customer 101 should be processed in the future. In some embodiments of the invention, the sender 101 is permitted to include a note to the recipient 125 along with the payment, such as a note explaining to the recipient the purpose of the payment.

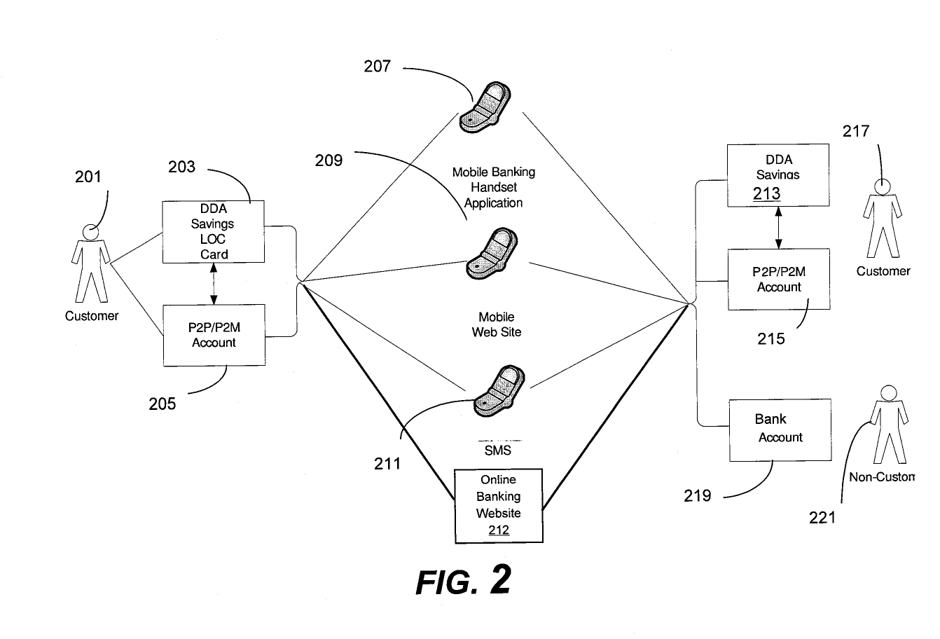

FIG. 2 is a block diagram illustrating the various ways through which a customer may make P2P payments in accordance with various embodiments of the invention. As illustrated, in some embodiments of the invention, a customer 201 who is signed up for the P2P payment service has the option to initiate P2P payments from a DDA, savings, line of credit, and/or credit card account 203 of the financial entity (and/or from a P2P-specific account 205 with the financial entity) through the financial entity's mobile banking website 209 or a mobile banking handset application 207 by providing any of the above-described alias information, e.g., phone number, email address, social networking ID, and/or other alias, along with a payment amount. In some embodiments of the invention, customers can alternatively or additionally initiate payments by sending a text message 211 to the financial entity, the text message including the receiver's phone number, email address, social networking ID, nickname, or other alias. In some embodiments, customers can alternatively or additionally use the financial institution's banking website 212, which may be hosted online or through a mobile banking platform, to initiate a payment using an alias. Whether via a mobile banking handset application 207, mobile website 209, short message service 211, or banking website 212, a receiver 217 associated with the financial entity may receive funds at the receiver's financial institution account (e.g., DDA, savings, or credit account 213 or P2P-specific account 215). A receiver 221 not associated with the financial entity may receive funds at the receiver's financial institution, or bank account 219 at another partner financial institution if the account is registered and associated with the alias and/or the receiver 221 may be prompted to register for the service and/or open an account with the financial institution in order to receive the payment from the customer 201.

It should be appreciated that embodiments of the invention described above permit an entity to send money to another entity even if the sending entity does not know any account information for the recipient entity and only knows a mobile telephone number or email address of the recipient entity. This can also result in better protection of personal account information. It should also be appreciated that some embodiments of the invention create a viral registration and/or account opening system that allows for customers of a financial institution to send payments to anyone outside the financial entity using an alias. In such embodiments, the non-customers are contacted using the alias and they are allowed to quickly open and/or register an account with the financial institution in order to receive the funds from the sender.

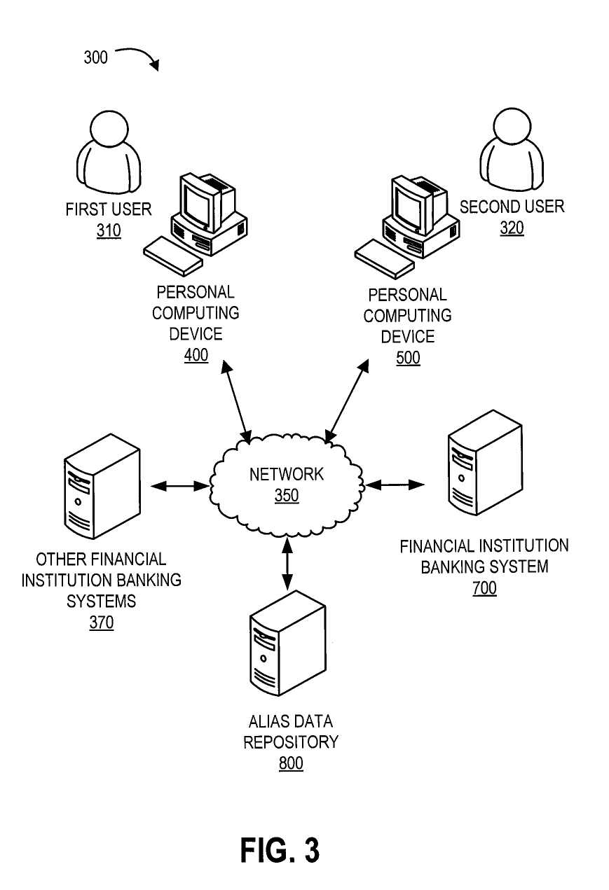

As described above, FIGS. 1 and 2 provide an overview of the alias-type P2P payment system and process of embodiments of the invention. FIGS. 3-10, described below, provide a more detailed description of some systems and methods of implementing embodiments the invention in banking environment, regardless of whether the banking environment is accessible online, through a mobile platform, or otherwise. Specifically, embodiments of the invention described below disclose a user-friendly banking interface and associated method that may be used by a user to: (1) receive information associated with a party to a financial transaction with a user; (2) determine, at least partially on the information associated with the party, that the party can participate in a P2P transaction with the user; and (3) populate a list of P2P transaction participants with an alias identifier.

### P2P Payment System and Environment

FIG. 3 provides a block diagram illustrating a banking P2P payment system and environment 300, in accordance with an embodiment of the invention. As illustrated in FIG. 3, the P2P payment environment 300 includes a first user 310 and a second user 320 where the first user 310 wants to send funds to the second user 320 via a P2P payment system. In other embodiments, the second user 320 may want to receive funds from the first user 310 via a P2P payment system. First user 310 and a second user 320 may each be a person, but each may also be a business (e.g., a merchant) or any other entity capable of sending or receiving funds.

The environment 300 also includes a personal computing device 400 belonging to first user 310 and personal computing device 500 belonging to second user 320. Personal computing device 400 and personal computing device 500 may be any device that employs a processor and memory and can perform computing functions, such as a personal computer or a mobile device. As used herein, a “mobile device” is any mobile communication device, such as a cellular telecommunications device (i.e., a cell phone or mobile phone), personal digital assistant (PDA), a mobile Internet accessing device, or other mobile device.

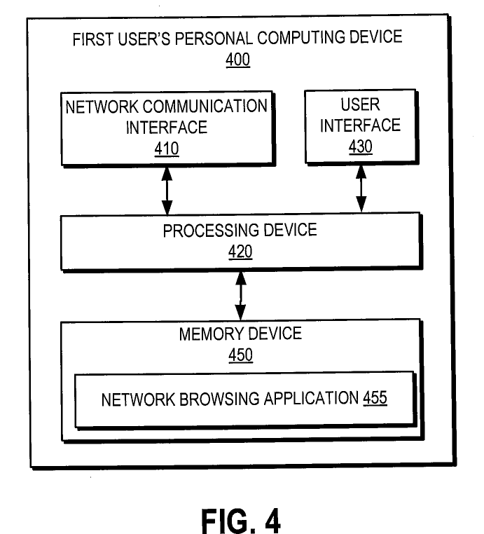

The personal computing devices 400 and 500 are configured to communicate over a network 350 with a financial institution banking system 700 (also referred to herein as banking system 700), alias data repository 800, and in some cases, one or more other financial institution banking systems 370. The first user's personal computing device 400, the second user's personal computing device 500, the financial institution banking system 700, an alias data repository 800, and any other participating financial institution banking systems 370 are each described in greater detail below with reference to FIGS. 4-8. The network 350 may include a local area network (LAN), a wide area network (WAN), and/or a global area network (GAN) or any other type of communications network or protocol. The network 350 may provide for wireline, wireless, or a combination of wireline and wireless communication between devices in the network. In one embodiment, the network 350 includes the Internet. In another embodiment, the network 350 includes a wireless telephone network (i.e., cellular network) that may include first, second, third, and/or fourth-generation cellular communication networks and/or the like. For example, the network 350 may include second-generation (2G) wireless communication protocols IS-136 (time division multiple access (TDMA)), GSM (global system for mobile communication), and/or IS-95 (code division multiple access (CDMA)), or with third-generation (3G) wireless communication protocols, such as Universal Mobile Telecommunications System (UMTS), CDMA2000, wideband CDMA (WCDMA) and/or time division-synchronous CDMA (TD-SCDMA), with fourth-generation (4G) wireless communication protocols, and/or the like.

In general, personal computing device 400 is configured to connect with the network 350 to log the first user 310 into a banking system 700. Banking system 700 may be accessed online via a banking website, through a mobile banking system or mobile banking application, or any other means in which a user can access banking functionality. The banking system 700 involves authentication of a first user in order to access the first user's account on the banking system 700. For example, in some embodiments, the banking system 700 is a system where a first user 310 logs into his/her account such that the first user 310 or other entity can access data that is associated with the first user 310. For example, in one embodiment of the invention, the banking system 700 is a mobile banking system maintained by a financial institution. In such an embodiment, the first user 310 can use the personal computing device 400 to log into the mobile banking system to access the first user's mobile banking account. In other embodiments of the invention, banking system 700 is an online banking system maintained by a financial institution. In such an embodiment, the first user 310 can use the personal computing device 400 to log into the online banking system to access the first user's online banking account. Regardless of whether banking system 700 is accessed online, through a mobile banking system or through a mobile banking application, logging into the banking system 700 generally requires that the first user 310 authenticate his/her identity using a user name, a passcode, a cookie, a biometric identifier, a private key, a token, and/or another authentication mechanism that is provided by the first user 310 to the banking system 700 via the personal computing device 400.

The financial institution's banking system 700 is in network communication with other devices, such as other financial institution banking systems 370, an alias data repository 800, and a personal computing device 500 that is configured to communicate with the network 350 to log a second user 320 into the banking system 700. In one embodiment, where at least one of personal computing device 400 and personal computer device 500 is a mobile device, the invention may provide an application download server such that software applications that support the mobile banking system 700 can be downloaded to the mobile device.

In some embodiments of the invention, the application download server is configured to be controlled and managed by one or more third-party data providers (not shown in FIG. 3) over the network 350. In other embodiments, the application download server is configured to be controlled and managed over the network 350 by the same entity that maintains the banking system 700.

In some embodiments of the invention, the alias data repository 800 is configured to be controlled and managed by one or more third-party data providers (not shown in FIG. 3) over the network 350. In other embodiments, the alias data repository 800 is configured to be controlled and managed over the network 350 by the same entity that maintains the financial institution's banking system 600. In other embodiments, the alias data repository 800 is configured to be controlled and managed over the network 350 by the financial institution implementing the P2P payment system of the present invention. In still other embodiments, the alias data repository 800 is a part of the banking system 700.

Referring now to FIG. 4, the personal computing device 400 associated with the first user 310 includes various features, such as a network communication interface 410, a processing device 420, a user interface 430, and a memory device 450. The network communication interface 410 includes a device that allows the personal computing device 400 to communicate over the network 350 (shown in FIG. 3). In addition, a network browsing application 455 is stored in the memory device 450. The network browsing application 455 provides for the first user to establish network communication with the banking system 700 (shown in FIG. 3) for the purpose of initiating a P2P payment, in accordance with embodiments of the present invention.

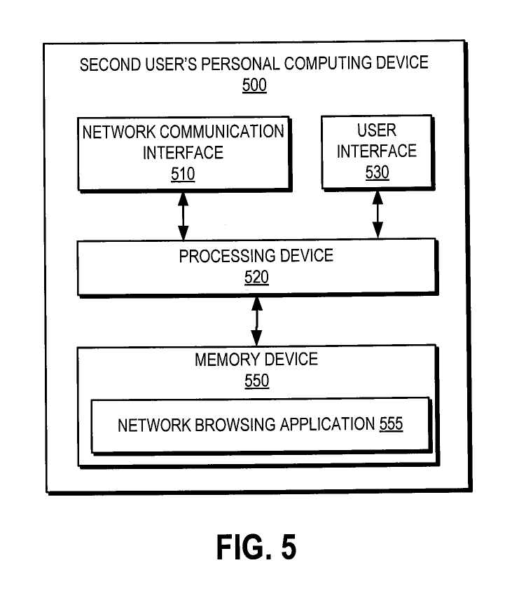

Referring now to FIG. 5, the personal computing device 500 associated with the second user 320 also includes various features, such as a network communication interface 510, a processing device 520, a user interface 530, and a memory device 550. The network communication interface 510 includes a device that allows the personal computing device 500 to communicate over the network 350 (shown in FIG. 3). In addition, a network browsing application 555 is stored in the memory device 550. The network browsing application 555 provides for the second user to establish network communication with a banking system 700 (shown in FIG. 3) for the purpose of registering an account and/or alias with the P2P payment system of the present invention and/or receiving a P2P payment, in accordance with embodiments of the invention.

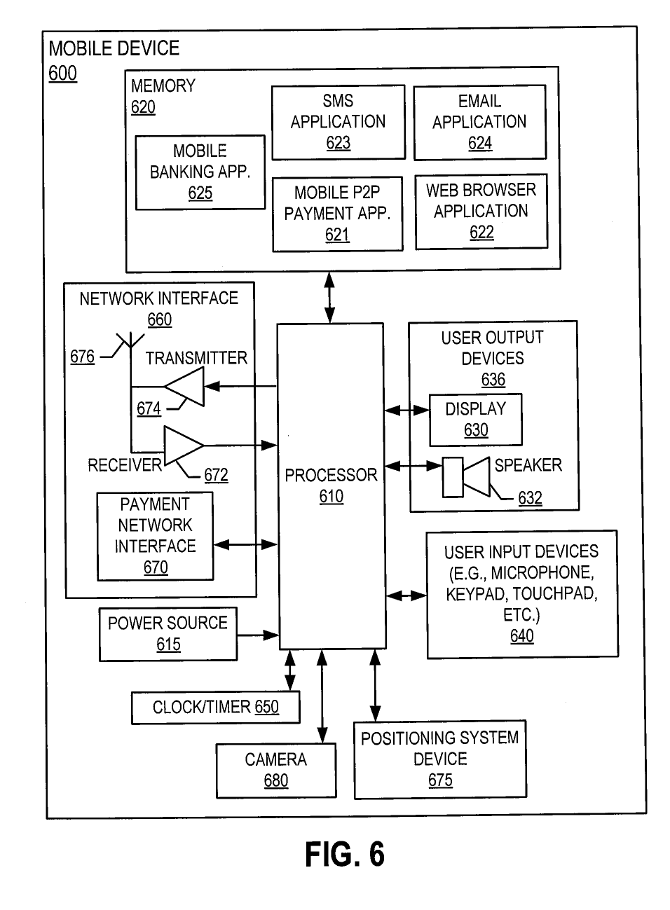

As discussed above, in some embodiments of the invention, at least one of personal computing device 400 and personal computing device 500 may be a mobile device. FIG. 6 provides a block diagram illustrating the personal computing device 400 and/or personal computing device 500 of FIG. 3 as mobile device 600, in accordance with embodiments of the invention. In one embodiment of the invention, the mobile device 600 is a mobile telephone. However, it should be understood, however, that a mobile telephone is merely illustrative of one type of mobile device 600 that may benefit from, employ, or otherwise be involved with embodiments of the present invention and, therefore, should not be taken to limit the scope of embodiments of the present invention. Other types of mobile devices 600 may include portable digital assistants (PDAs), pagers, mobile televisions, gaming devices, laptop computers, cameras, video recorders, audio/video player, radio, GPS devices, or any combination of the aforementioned.

The mobile device 600 generally includes a processor 610 communicably coupled to such devices as a memory 620, user output devices 636, user input devices 640, a network interface 660, a power source 615, a clock or other timer 650, a camera 680, and a positioning system device 675. The processor 610, and other processors described herein, generally include circuitry for implementing communication and/or logic functions of the mobile device 600. For example, the processor 610 may include a digital signal processor device, a microprocessor device, and various analog to digital converters, digital to analog converters, and/or other support circuits. Control and signal processing functions of the mobile device 600 are allocated between these devices according to their respective capabilities. The processor 610 thus may also include the functionality to encode and interleave messages and data prior to modulation and transmission. The processor 610 can additionally include an internal data modem. Further, the processor 610 may include functionality to operate one or more software programs, which may be stored in the memory 620. For example, the processor 610 may be capable of operating a connectivity program, such as a web browser application 622. The web browser application 622 may then allow the mobile device 600 to transmit and receive web content, such as, for example, location-based content and/or other web page content, according to a Wireless Application Protocol (WAP), Hypertext Transfer Protocol (HTTP), and/or the like.

The processor 610 is configured to use the network interface 660 to communicate with one or more other devices on the network 350. In this regard, the network interface 660 includes an antenna 676 operatively coupled to a transmitter 674 and a receiver 672 (together a “transceiver”). The processor 610 is configured to provide signals to and receive signals from the transmitter 674 and receiver 672, respectively. In some embodiments where network 350 is a wireless telephone network, the signals may include signaling information in accordance with the air interface standard of the applicable cellular system of the wireless telephone network. In this regard, the mobile device 600 may be configured to operate with one or more air interface standards, communication protocols, modulation types, and access types. By way of illustration, the mobile device 600 may be configured to operate in accordance with any of a number of first, second, third, and/or fourth-generation communication protocols and/or the like. For example, the mobile device 600 may be configured to operate in accordance with second-generation (2G) wireless communication protocols IS-136 (time division multiple access (TDMA)), GSM (global system for mobile communication), and/or IS-95 (code division multiple access (CDMA)), or with third-generation (3G) wireless communication protocols, such as Universal Mobile Telecommunications System (UMTS), CDMA2000, wideband CDMA (WCDMA) and/or time division-synchronous CDMA (TD-SCDMA), with fourth-generation (4G) wireless communication protocols, and/or the like. The mobile device 600 may also be configured to operate in accordance with non-cellular communication mechanisms, such as via a wireless local area network (WLAN) or other communication/data networks.

The network interface 660 may also include a payment network interface 670. The payment network interface 670 may include software, such as encryption software, and hardware, such as a modem, for communicating information to and/or from one or more devices on a network 350. For example, the mobile device 600 may be configured so that it can be used as a credit or debit card by, for example, wirelessly communicating account numbers or other authentication information to a terminal of the network 350.

As described above, the mobile device 600 has a user interface that is, like other user interfaces described herein, made up of user output devices 636 and/or user input devices 640. The user output devices 636 include a display 630 (e.g., a liquid crystal display or the like) and a speaker 632 or other audio device, which are operatively coupled to the processor 610. The user input devices 640, which allow the mobile device 600 to receive data from a user such as the first user 310 or second user 320, may include any of a number of devices allowing the mobile device 600 to receive data from a user, such as a keypad, keyboard, touch-screen, touchpad, microphone, mouse, joystick, other pointer device, button, soft key, and/or other input device(s). The user interface may also include a camera 680, such as a digital camera.

The mobile device 600 may also include a positioning system device 675 that is configured to be used by a positioning system to determine a location of the mobile device 600. For example, the positioning system device 675 may include a GPS transceiver. In some embodiments, the positioning system device 675 is at least partially made up of the antenna 676, transmitter 674, and receiver 672 described above. For example, in one embodiment, triangulation of cellular signals may be used to identify the approximate location of the mobile device 600. In other embodiments, the positioning system device 675 includes a proximity sensor or transmitter, such as an RFID tag, that can sense or be sensed by devices known to be located proximate a merchant or other location to determine that the consumer mobile device 600 is located proximate these known devices.

The mobile device 600 further includes a power source 615, such as a battery, for powering various circuits and other devices that are used to operate the mobile device 600. Embodiments of the mobile device 600 may also include a clock or other timer 650 configured to determine and, in some cases, communicate actual or relative time to the processor 610 or one or more other devices.

The mobile device 600 also includes a memory 620 operatively coupled to the processor 610. As used herein, memory includes any computer readable medium (as defined herein below) configured to store data, code, or other information. The memory 420 may include volatile memory, such as volatile Random Access Memory (RAM) including a cache area for the temporary storage of data. The memory 620 may also include non-volatile memory, which can be embedded and/or may be removable. The non-volatile memory can additionally or alternatively include an electrically erasable programmable read-only memory (EEPROM), flash memory or the like.

The memory 620 can store any of a number of applications which comprise computer-executable instructions/code executed by the processor 610 to implement the functions of the mobile device 600 described herein. For example, the memory 620 may include such applications as a conventional web browser application 622, a mobile P2P payment application 621, a mobile banking application 625, and SMS application 623 and/or an email application 624. These applications also typically provide a graphical user interface (GUI) on the display 630 that allows the first user 310 and second user 320 to communicate with the other respective user, the mobile banking system 700, and/or other devices or systems. In one embodiment of the invention, when the first user 310 and/or second user 320 decides to enroll in the mobile banking program, the first user 310 and/or second user 320 downloads or otherwise obtains the mobile banking application 625 from the mobile banking system 700 or from a distinct application server. In other embodiments of the invention, the first user 310 or second user 320 interacts with the mobile banking system 700 via the web browser application 622 in addition to, or instead of, the mobile P2P payment application 621.

The memory 620 can also store any of a number of pieces of information, and data, used by the mobile device 600 and the applications and devices that make up the mobile device 600 or are in communication with the mobile device 600 to implement the functions of the mobile device 600 and/or the other systems described herein. For example, the memory 620 may include such data as user authentication information, aliases, etc.

As used herein, a “processing device,” such as the processing device 420 or the processing device 520, generally refers to a device or combination of devices having circuitry used for implementing the communication and/or logic functions of a particular system. For example, a processing device 420 or 520 may include a digital signal processor device, a microprocessor device, and various analog-to-digital converters, digital-to-analog converters, and other support circuits and/or combinations of the foregoing. Control and signal processing functions of the system are allocated between these processing devices according to their respective capabilities. The processing device 420 or 520 may further include functionality to operate one or more software programs based on computer-executable program code thereof, which may be stored in a memory. As the phrase is used herein, a processing device 420 or 520 may be “configured to” perform a certain function in a variety of ways, including, for example, by having one or more general-purpose circuits perform the function by executing particular computer-executable program code embodied in computer-readable medium, and/or by having one or more application-specific circuits perform the function. In some embodiments of the invention where personal computing device 400 and/or personal computing device 500 are a mobile device 600, processing device 420 and/or 520 may comprise processor 610.

As used herein, a “user interface” 430 or 530 generally includes a plurality of interface devices and/or software that allow a customer to input commands and data to direct the processing device to execute instructions. For example, the user interface 430 and 530 presented in FIG. 4 and FIG. 5, respectively, may include a graphical user interface (GUI) or an interface to input computer-executable instructions that direct the processing devices 420 and 520, respectively, to carry out specific functions. The user interface 430 and 530 employ certain input and output devices to input data received from the first user 310 or second user 320 or output data to the first user 310 or second user 320. These input and output devices may include a display, mouse, keyboard, button, touchpad, touch screen, microphone, speaker, LED, light, joystick, switch, buzzer, bell, and/or other customer input/output device for communicating with one or more customers. In some embodiments of the invention where personal computing device 400 and/or personal computing device 500 are a mobile device 600, user input 430 and/or 530 may comprise all or portions of user input devices 640 and user output devices 636.

As used herein, a “memory device” 450 or 550 generally refers to a device or combination of devices that store one or more forms of computer-readable media for storing data and/or computer-executable program code/instructions. Computer-readable media is defined in greater detail below. For example, in one embodiment, the memory device 450 or 550 includes any computer memory that provides an actual or virtual space to temporarily or permanently store data and/or commands provided to the processing device 420 or 520 when it carries out its functions described herein. In some embodiments of the invention where personal computing device 400 and/or personal computing device 500 are a mobile device 600, memory device 450 and/or 550 may comprise memory 620.

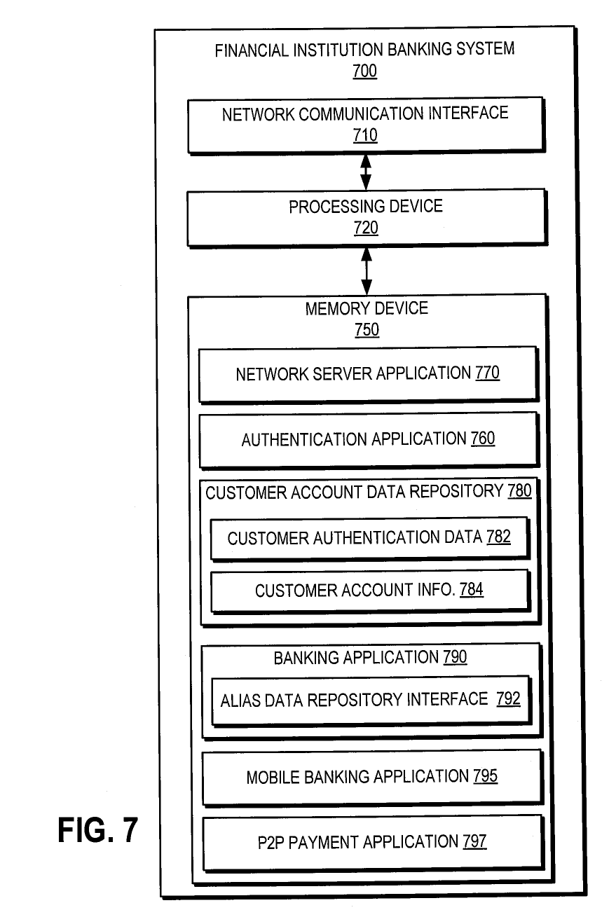

FIG. 7 provides a block diagram illustrating the banking system 700 in greater detail, in accordance with an embodiment of the invention. As illustrated in FIG. 7, in one embodiment of the invention, the banking system 700 includes a processing device 720 operatively coupled to a network communication interface 710 and a memory device 750. In certain embodiments, the banking system 700 is operated by a first entity, such as a financial institution, while in other embodiments, the banking system 700 is operated by an entity other than a financial institution.

It should be understood that the memory device 750 may include one or more databases or other data structures/repositories. The memory device 750 also includes computer-executable program code that instructs the processing device 720 to operate the network communication interface 710 to perform certain communication functions of the banking system 700 described herein. For example, in one embodiment of the banking system 700, the memory device 750 includes, but is not limited to, a network server application 770, an authentication application 760, a customer account data repository 780, which includes customer authentication data 782 and customer account information 784, banking application 790 which includes an alias data repository interface 792, and other computer-executable instructions or other data. In other embodiments of the invention, where at least one of personal computing device 400 and personal computing device 500 is a mobile device, memory device 750 may include a mobile banking application 795 and/or mobile P2P payment application 797. The computer-executable program code of the network server application 770, the authentication application 760, or the banking application 790 may instruct the processing device 720 to perform certain logic, data-processing, and data-storing functions of the banking system 700 described herein, as well as communication functions of the banking system 700.

In one embodiment, the customer account data repository 780 includes customer authentication data 782 and customer account information 784. The network server application 770, the authentication application 760, and the banking application 790 are configured to implement customer account information 784, the customer authentication data 782, and the alias data repository interface 792 when authenticating the customer 101 (or the first user 310) to the banking system 700.

As used herein, a “communication interface” generally includes a modem, server, transceiver, and/or other device for communicating with other devices on a network, and/or a user interface for communicating with one or more customers. Referring again to FIG. 7, the network communication interface 710 is a communication interface having one or more communication devices configured to communicate with one or more other devices on the network 350, such as the personal computing device 400, the personal computing device 500, the other financial institution banking systems 370, and the alias data repository 800. The processing device 720 is configured to use the network communication interface 710 to transmit and/or receive data and/or commands to and/or from the other devices connected to the network 350.

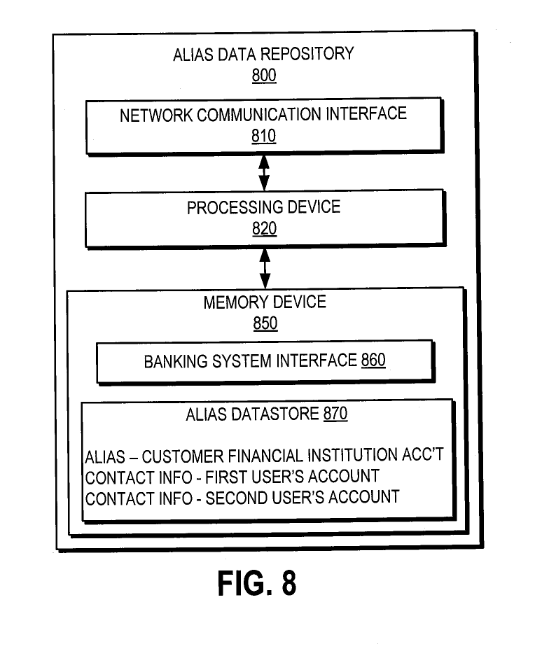

FIG. 8 provides a block diagram illustrating an alias data repository 800, in accordance with an embodiment of the invention. In one embodiment of the invention, the alias data repository 800 is operated by a second entity that is a different or separate entity from the first entity (e.g., the financial institution) that, in one embodiment of the invention, implements the banking system 700. In one embodiment, the alias data repository 800 could be part of the banking system 700. In another embodiment, the alias data repository 800 is a distinct entity from the banking system 700. As illustrated in FIG. 8, the alias data repository 800 generally includes, but is not limited to, a network communication interface 810, a processing device 820, and a memory device 850. The processing device 820 is operatively coupled to the network communication interface 810 and the memory device 850. In one embodiment of the alias data repository 800, the memory device 850 stores, without limitation banking system interface 860 and an alias data store 870. The alias data store 870 stores data including, but not limited to, an alias for a customer's financial institution account (including but not limited to first user 310 and/or second user 320), contact information, such as mobile number or email address for the first user's 310 account, and contact information, such as a mobile number and/or email address for the second user's 320 account. The alias data store 870 may also store other information relating to how to contact first user 310 and/or second user 320, including but not limited to address information. In one embodiment of the invention, both the banking system interface 860 and the alias data store 870 may associate with applications having computer-executable program code that instructs the processing device 820 to operate the network communication interface 810 to perform certain communication functions involving the alias data store 870 described herein. In one embodiment, the computer-executable program code of an application associated with the alias data store 870 may also instruct the processing device 820 to perform certain logic, data processing, and data storing functions of the application associated with the alias data store 870 described herein. An alias, as defined in this invention, is not limited to just a mobile device number or an email address.

The network communication interface 810 is a communication interface having one or more communication devices configured to communicate with one or more other devices on the network 350. The processing device 820 is configured to use the network communication interface 810 to receive information from and/or provide information and commands to a personal computing device 400, a personal computing device 500, other financial institution banking systems 370, the banking system 700 and/or other devices via the network 350. In some embodiments, the processing device 820 also uses the network communication interface 810 to access other devices on the network 350, such as one or more web servers of one or more third-party data providers. In some embodiments, one or more of the devices described herein may be operated by a second entity so that the third-party controls the various functions involving the alias data repository 800. For example, in one embodiment of the invention, although the banking system 700 is operated by a first entity (e.g., a financial institution), a second entity operates the alias data repository 800 that stores the alias details for the customer's financial institution accounts and other information about customers.

As described above, the processing device 820 is configured to use the network communication interface 810 to gather data from the various data sources, including but not limited to third party directories, third party financial institutions, third party memory devices, and/or third party websites. The processing device 820 stores the data that it receives in the memory device 850. In this regard, in one embodiment of the invention, the memory device 850 includes datastores that include, for example: (1) aliases for customer financial institution account numbers and routing information, (2) information about sending and receiving users' mobile device numbers, email addresses, or other contact information, which may have been received from banking system 700; (3) a list of customer IDs or authentication data received from the banking system 700; and/or (4) customer credentials (e.g., a customer ID) received from the customer's personal computing device 400 or received from the banking system 700 in response to the customer accessing the banking system 700.

In one embodiment of the invention, an application server is provided to support various supporting systems on the network 350, including any wireless telephone network that comprises network 350. The application server includes a network communication interface, a processing device, and a memory device. The network communication interface and the processing device are similar to the previously described network communication interface 710 and the processing device 720 previously described. For example, the processing device is operatively coupled to the network communication interface and the memory device. In one embodiment of the application server, the memory device includes a network browsing application having computer-executable program code that instructs the processing device to operate the network communication interface to perform certain communication functions of the application download server described herein.

As discussed above, in one embodiment of the invention, an application download server (not shown in FIG. 3) might be provided. The application download server may include a network communication interface, a processing device, and a memory device. The network communication interface and processing device are similar to the previously described network communication interface 710 and the processing device 720 previously described. For example, the processing device is operatively coupled to the network communication interface and the memory device. In one embodiment of the application download server, the memory device includes a network browsing application having computer-executable program code that instructs the processing device to operate the network communication interface to perform certain communication functions of the application download server described herein. In some embodiments of the invention, the application download server provides applications that are to be downloaded to a qualified customer's mobile device or personal computing device.

### Method of Populating a List of P2P Transaction Participants

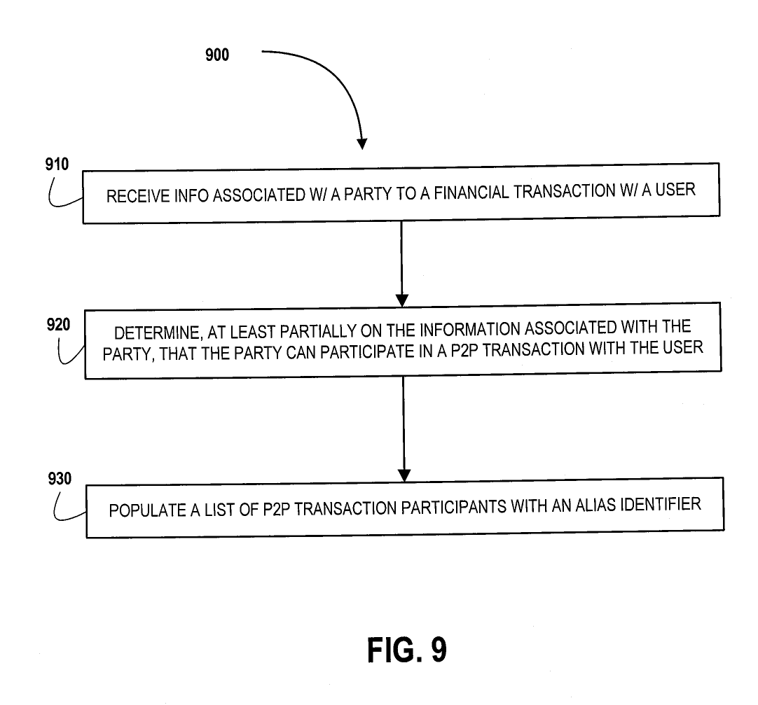

As discussed in relation to FIGS. 1-8, the present invention discloses a system and method whereby a user may send a P2P payment to an eligible third party. As described in relation to FIG. 1, in some embodiments of the invention, the user may specify an alias identifier of the third party to whom the user wants to send a P2P payment. In some embodiments, the user may use a personal computing device to type or otherwise input the alias identifier to whom the user wants to send a P2P payment. In other embodiments, the user may access a list of stored alias identifiers and choose an alias identifier from the list. The following FIGS. 9-11 disclose a method of populating a list of P2P transaction participants. In particular, FIGS. 9-11 disclose a method of populating a list of P2P transaction participants that may be used by to transmit a P2P payment to two parties according to the method of FIGS. 1 and 2.

FIG. 9 illustrates a general process flow 900 for populating a list of P2P transaction participants. In some embodiments, the process flow 900 is performed by an apparatus (i.e., one or more apparatuses) having hardware and/or software configured to perform one or more portions of the process flow 900. In some embodiments, the system of FIG. 3 is configured to perform process flow 900. In some embodiments, as represented by block 910, the system configured to perform process flow 900 receives information associated with a party to a financial transaction with a user. As represented in block 920, the system is also configured to determine, at least partially on the information associated with the party, that the party can participate in a P2P transaction with the user. In addition, as represented in block 930, the system is configured to populate a list of P2P transaction participants with an alias identifier.

The term “determine,” in some embodiments, is meant to have one or more of its ordinary meanings (i.e., its ordinary dictionary definition(s)), but in other embodiments, that term is meant to have one or more ordinary meanings of one or more of the following terms: decide, conclude, verify, ascertain, find, discover, learn, calculate, observe, read, and/or the like. Further, in some embodiments, the phrase “based at least partially on,” is meant to have one or more of its ordinary meanings, but in other embodiments, that phrase is meant to have one or more ordinary meanings of one or more of the following terms and/or phrases: as a result of, because, after, if, when, in response to, and/or the like.

It will also be understood that the system having the process flow 900 can include one or more separate and/or different apparatuses. For example, in some embodiments, a first apparatus (e.g., the banking system 700 described in connection with FIG. 3) is configured to perform the portions of the process flow 900 represented by blocks 910 and 930, and a second apparatus (e.g., alias data repository 800, personal computing device 400, personal computing device 500) is configured to perform the portion of the process flow 900 represented by block 920. Alternatively, in other embodiments, a single apparatus (e.g., the personal computing device 400, personal computing device 500, or the banking system 700, etc.) is configured to perform all of the portions of process flow 900 represented by blocks 910-930.

Regarding block 910, the term “financial transaction” means any type of financial transaction in which there is a transfer of money, funds or other items of value. In some embodiments, the term financial transaction means a transaction in which a payment is made in exchange for goods, products, and/or services. In other embodiments, the term financial transaction means transferring or sending money or other funds without an exchange of goods, products, and/or services (e.g., a donation, a gift, etc.). As one of ordinary skill in the art will appreciate, the term “financial transaction” is not limited to any type financial transaction in which there is a transfer of money or other funds. Additionally, the term “financial transaction” may include any financial transaction where anything of value, not merely money, is exchanged.

In some embodiments of process flow 900, the term “user” refers to the individual or entity that pays, transfers, or sends money, funds, etc. as part of a financial transaction. In these embodiments, the term “party” thus refers to the individual or entity that receives the user's money, funds, etc. as part of the financial transaction.

Alternatively, in other embodiments of process flow 900, the term “user” refers to the individual or entity that receives money, funds, etc. as part of the financial transaction. In some of these embodiments, the user may be providing products, goods or services in exchange for money, funds, etc. In the embodiments where the term “user” refers to the individual or entity that receives money, funds, etc. as part of the financial transaction, then the term “party” refers to the individual or entity that is pays, transfers, or sends money, funds, etc. as part of the financial transaction.

In all embodiments of the invention, the terms “party” and “user” may be any number and/or type of “parties” and “users”, respectively. In some embodiments, the party or user may be an individual. In some other embodiments, the party or user is a merchant or other commercial entity. In some other embodiments, the party or user is a financial institution. In yet some other embodiments, the party or user is an organization or other non-commercial entity. As used herein, the term “party” means the party to a financial transaction with a user. For clarification, the phrase “third party” as used herein has its ordinary meaning.

Further regarding block 910, the phrase “information associated with a party” can be any amount or type of information associated with a party. In some embodiments, the information associated with a party is the party's name and/or address. In other embodiments, the information associated with a party is the party's bank account number. In yet some other embodiments, the information associated with a party is an indication that a user has selected the party's name through a user interface. In still some other embodiments of the invention, the information associated with a party is an indication that a user would like to add the party's alias to a list of P2P transaction participants.

In some embodiments, the system having the process flow 900 receives the information associated with a party through a network. In some embodiments, the system receives the information associated with a party via a wireless and/or contactless network. In some embodiments, the system receives the information associated with a party via second-generation (2G) wireless communication protocols (e.g., IS-136 (time division multiple access (TDMA), GSM (global system for mobile communication), and/or IS-95 (code division multiple access (CDMA)), third-generation (3G) wireless communication protocols (e.g., Universal Mobile Telecommunications System (UMTS), CDMA2000, wideband CDMA (WCDMA) and/or time division-synchronous CDMA (TD-SCDMA)), fourth-generation (4G) wireless communication protocols, and/or the like. In some other embodiments, the system having the process flow 900 is configured to receive the information associated with a party in accordance with non-cellular communication mechanisms, such as via a wireless local area network (WLAN), global area network (GAN), a wide-area network (WAN), the Internet, and/or other communication/data networks. In other embodiments, the system having the process flow 900 receives the information associated with a party through wired communications. In some embodiments, the wired communications may be between network components, such as between a memory storage device and processing device.

In some embodiments, the system configured to perform the process flow 900 may automatically receive information associated with a party. In some embodiments, the system may review information relating to transactions between a user and third parties and receive all or a portion of the information. The information may be stored in memory devices operated by a user, a financial institution associated with a user, and/or a third party, where each memory device may be connected via a wireless or wired communication network.

In some embodiments, the system configured to perform the process flow 900 may review information that is available to a user via an online banking website, mobile banking application, or P2P payment application. For instance, in some embodiments, the system may receive information associated with a party by reviewing information relating to transactions involving the user. In some embodiments, the system may only review information relating to a set of transactions, where the set of transactions is defined by a date range. The date range may be preset (i.e., one week) or in other embodiments, the user and/or system can change the date range that determines the number of transactions in the set. In some embodiments of the invention, the system may review an image of check relating to a transaction. In other embodiments, the system may review information relating to a transaction using a credit or debit card (i.e., card number, transaction number, etc.) As one of skill in the art will appreciate, the system may review any type of information that relates to a financial transaction. Further, in some embodiments, the system may automatically review such information and in other embodiments, the system may only review such information upon indication by the user.

In reviewing information relating to transactions between a user and third parties, the system may use any means, including text recognition, optical character recognition, pattern recognition technologies and/or any technology relating to the searching of data stored in a memory device.

In some embodiments, the system may receive information associated with a party because that party is frequently the subject of financial transactions with a user. For example, if the system reviews information relating to financial transactions between the user and third parties during a period of one month, and a certain individual or entity is subject to over 20% of the transactions, then the system may receive information associated with that individual or entity. It should be understood that the 20% threshold is just an example, and the system could use any metric and/or value to determine whether a third party is frequently the subject of financial transactions with a user. In other embodiments, the system may receive information associated with a party because the party is subject to the most recent financial transaction with a user. In yet some other embodiments, the system may receive information associated with a party because the party is subject to the largest (or smallest) financial transaction with a user.

In other embodiments of the invention, the system configured to perform process flow 900 may only receive information associated with a party upon indication by a user. In some embodiments, a user may access information available via an online banking website, mobile banking application and/or P2P payment application, including information relating to the third parties with whom the user has recently conducted financial transactions. In some embodiments, the user may indicate the desire to conduct future P2P transaction with a certain party. In other embodiments, the user may indicate the desire to add the party to a list of P2P transaction participants. In some embodiments, the user makes an indication by using the functionality of a personal computer device, such as personal computing device 400 or 500.

Regarding block 920, in some embodiments of the invention, the phrase “can participate in a P2P transaction with the user” refers to a party to whom a user can send money or other funds from the user's financial institution account(s) directly to the party's financial institution account(s). In other embodiments of the invention, the phrase “can participate in a P2P transaction with the user” refers to a party from whom a user can receive money or other funds from the party's financial institution account(s) directly to the users' financial institution account(s). As discussed above, the term “P2P payments” is intended to include person-to-person (P2P), person-to-merchant (P2M), merchant-to-merchant (M2M), and merchant-to-person (M2P) unless specifically stated otherwise. The phrase person-to-person (P2P) is also intended to include transactions involving entities that are not merchants, such as non-profit entities, foundations, and/or other organizations.

The system configured to perform the process flow of FIG. 9 may use any means to determine that the party can participate in P2P transaction with the user. In some embodiments, the system configured to perform the process flow of FIG. 9 compares the information associated with the party to any type of information about parties who can participate in P2P transactions with the user. As used herein, the term “stored information” shall mean any type of information about parties who can participate in P2P payments transactions with the user. According to some embodiments of the invention, if information associated with the party matches, either in whole or in part, stored information, then the system determines that the party can participate in P2P transactions with the user.

In other embodiments of the invention, the system compares other data, which is different than the information associated with the party, with stored information. For instance, in some embodiments where the information associated with the party is an indication from the user that the user would like to add the party's alias to a list of P2P transaction participants, the system may then compare the party's name or any other data to stored information to determine if the party can participate in a P2P transaction with the user. The other data may include, without limitation, the party's name, the party's address, the party's bank account number, etc.

Stored information may be any number and/or type of information that indicates that a party that can participate in a P2P transaction with the user. In some embodiments of the invention, stored information may comprise all or any portion of the following information: a individual or entity's name, an individual or entity's address, the name of a financial institution in which an individual or entity has an account, an account number, a routing number, or a tax ID number. In some other embodiments of the invention, stored information may include information that an individual or entity has previously participated in a P2P transaction with the user or a financial transaction involving the same financial institution as the user. In some embodiments, the stored information may be stored in one or more memory devices of the one or more apparatuses that perform the portions of the process flow 900. In other embodiments, the stored information may be stored in the memory device of a third party and accessible to one or more of the apparatuses that perform the portions of process flow 900. In some embodiments, the stored information is added to the memory device by the user. In other embodiments, the stored information is added to the memory device by a financial institution. In yet some other embodiments, the stored information is added to the memory device by a third party that is not the user or a financial institution.

In some embodiments of the invention, the system may use the information associated with the party to contact the party to determine if the party can participate in P2P transactions with the user. For example, if the information associated with the party is the party's email address, the system may send the party an email, where the email provides a means for the party to confirm that the party can participate in P2P payments with the user. In other embodiments, the system may access contact information that may be stored in a memory device to contact the party.

In some embodiments of block 920, if the system configured to perform the process flow of FIG. 9 determines that the party cannot participate in P2P transactions with the user, then the system may send a notification to the party, the notification telling the party that the party will be able to participate in P2P transactions with the user if the party registers an existing financial institution account that is eligible for P2P transactions and/or opens a new financial institution account that is eligible for P2P transactions. In some embodiments, the notification may be a text message to the party. In other embodiments, the notification may be an email message to the party. As one of skill in the art will appreciate, the notification may take any form and it may be sent to the party through any type of communication medium.

Regarding block 930 the phrase “list of P2P transaction participants” means any type of list that is used in connection with a P2P transaction involving the user. In some embodiments of the invention, the list of P2P transaction participants is a list of payment recipients to whom a party can send a P2P payment. In other embodiments of the invention, the list of P2P transaction participants may be a list of payment recipients to whom the user can send a P2P payment. In all embodiments, the list may comprise an interactive list of individuals or entities from which the party or user, respectively, may select the recipient of a P2P payment according the method described in FIGS. 1 and 2. In some embodiments, the list of payment recipients would be accessible by the party or user, respectively, via a banking website, mobile banking application or P2P payment application.

In other embodiments of the invention, the phrase “list of P2P transaction participants” may be a list of individuals or entities authorized to send P2P payments to the user. In such embodiments, the list of P2P transaction participants may be accessible to the user via a banking website, mobile banking application or P2P payment application.

As one of ordinary skill in the art will appreciate, the list of P2P transaction participants may take any form and may be presented to the user and/or party in any format. In some embodiments, the list of P2P transaction participants may be integrated into a website. In other embodiments, the list of payment recipients may be integrated into a software program, including but not limited to a mobile application. Further, in some embodiments, the list of P2P transaction participants may be interactive, such that the user and/or party may select an entry contained in the list.

Further regarding block 930, the term “populate” generally means adding an alias identifier to the list of P2P transaction participants. In some embodiments of the invention, the term “populate” means adding the alias identifier of the party to a list of payment recipients to whom the user may make P2P payments. In other embodiments of the invention, the term “populate” means adding the alias identifier of the user to a list of payment recipients to whom a party can make P2P payments. In other embodiments of the invention, the term “populate” means adding the alias identifier of a party to a list of individuals or entities that the user is authorizing to send P2P payments to the user.

In some embodiments of the invention, the system configured to perform the process flow 900 may automatically populate the list of P2P transaction participants with an alias identifier. In some other embodiments, the system configured to perform the process flow 900 will only populate the list of P2P transaction participants with an alias identifier after it has received an indication to do so by the user and/or party.

While block 930 discloses the populating of a list of payment recipients with an alias identifier, the system may also populate the list of P2P transaction participants with any other name, text, term, image or symbol that could represent the an alias identifier. For example, in some embodiments, the system may enable the user to suggest a nickname for the party's alias identifier and that nickname would be populated in the list of payment recipients.

In some embodiments of general process flow 900, block 930 may also include the step of allowing the user and/or the party to customize future P2P transactions. In some embodiments where the user makes a P2P payment to the party, the user may specify which financial institution account it would like to use in conjunction with future P2P payments to the party. In some further embodiments, the user may schedule P2P payments to the party, including but not limited to scheduling one-time or reoccurring payments, payment amounts, and/or any other criteria that would characterize a future P2P payment.

In other embodiments, where the user receives P2P payments from the party, the user may specify which financial institution account it would like to use in conjunction with the receipt of P2P payments from that party. For example, if the user selects a certain bank account, then all or some of the future P2P payments from that party will be transferred to the specified bank account of the user.

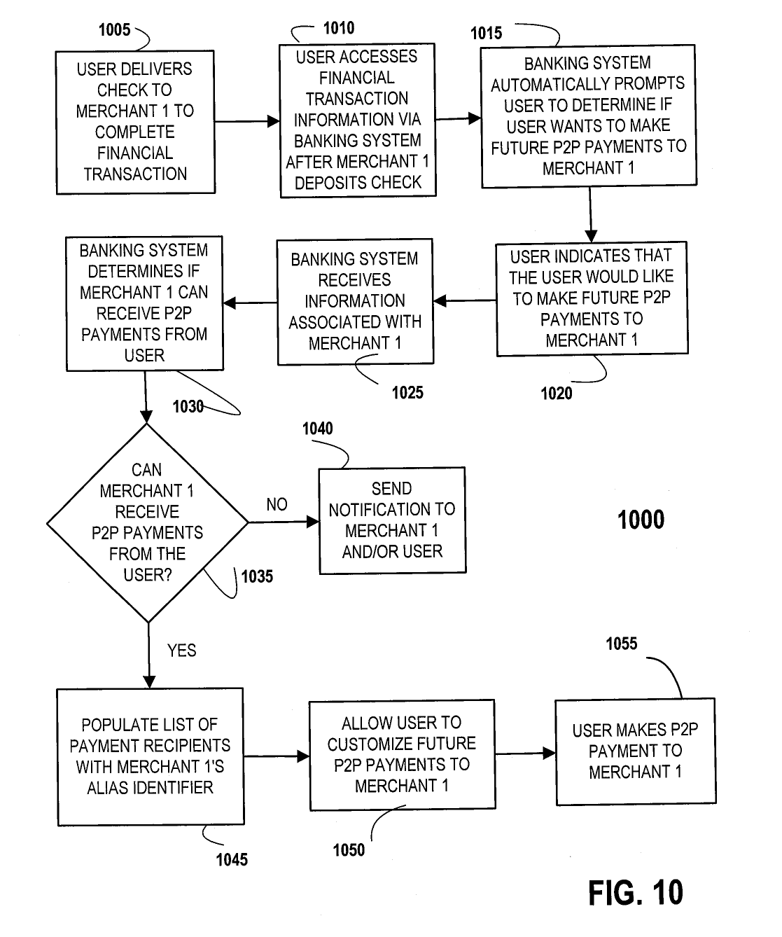

Referring now to FIG. 10, a more-detailed process flow 1000 for populating a list of P2P transaction participants, in accordance with an embodiment of the present invention is presented. Process flow 1000 represents an embodiment of process flow 900 in which the user engaged in a previous financial transaction with a party (L e., Merchant 1) in which the user paid the party (see, e.g., block 1005).

In some embodiments, one or more portions of the process flow 1000 are performed by a system having hardware and/or software configured to perform one or more portions of the process flow 1000. In some of these embodiments, the system configured to perform the process flow 900 is also configured to perform the process flow 1000. As such, it will be understood that the process flow 1000 illustrated in FIG. 10 represents an example embodiment of the process flow 900 described in connection with FIG. 9.

As described below, in the embodiment of process flow 1000, banking system 700 is configured to perform the processes of blocks 1010 to 1055. However, in other embodiments, all or portions of process flow 1000 may be accomplished by a mobile banking application or P2P payment application that is stored in the memory of personal computing device 400, where personal computing device 400 is a mobile device 600. Additionally, in other embodiments, any one of the apparatuses of FIG. 3, either alone or in combination with the other apparatuses of FIG. 3, may be configured to perform process flow 1000.

As represented in block 1005, the user delivers a check to Merchant 1 to complete a financial transaction between Merchant 1 and user. In this embodiment of the invention, the user is an embodiment of first user 310 and Merchant 1 is an embodiment of second user 320. As of one ordinary skill in the art will appreciate, the financial transaction between Merchant 1 and user can be any type of financial transaction. While the embodiment described in relation to process flow 1000 describes a financial transaction between a user and Merchant 1, the invention is not limited to financial transactions between only merchants and individuals.

At block 1005, the user delivers the check to Merchant 1 according to any method. In some embodiments of the invention, the user hand delivers the check to Merchant 1. In other embodiments of the invention, the user mails the check to Merchant 1. In other embodiments, the user could deliver the check to Merchant 1 through the use of the functionality of an online banking website or mobile banking application. As one of skill in the art will appreciate, in other embodiments, the user may use other payment methods to complete the financial transaction, such as use a credit card, debit card, etc.

At block 1010, the user uses personal computing device 400 to access financial transaction information via a banking system 700. In some embodiments, the user accesses the banking system 700 online through the use of a bank website. In other embodiments, where personal computing device 400 is a mobile device 600, the user accesses the banking system 700 through the use of a mobile banking application stored on mobile device 600. In other embodiments, the user could access the banking system 700 through the use of a P2P payment application.

In the embodiment depicted in block 1010, the user accesses financial transaction information after Merchant 1 has deposited the check. As such, in this embodiment, when the user accesses financial transaction information, the user will see information related to the financial transaction between the user and Merchant 1, as described in relation to block 1005. The user may see any type of information related to the financial transaction between the user and Merchant 1, including but not limited to: Merchant 1's name, Merchant 1's address, the date of the financial transaction between the user and Merchant 1, the amount of the financial transaction between the user and Merchant 1, the check number of the check that the user gave to Merchant 1, and/or an image of the check that the user gave to Merchant 1.

At block 1015, the banking system 700 automatically prompts the user to determine in the user wants to make future P2P payments to Merchant 1. In some embodiments, this prompt appears on personal computing device 400. In some embodiments of the invention, the banking system 700 may prompt the user after reviewing information related to financial transactions between the user and other parties and determining that the financial transaction between the user and Merchant 1 is the most recent financial transaction. In other embodiments, the banking system 700 may prompt the user after reviewing the information related to financial transactions between the user and other parties and determining that the financial transaction between the user and Merchant 1 is the largest (or smallest) financial transaction. In other embodiments, the banking system 700 may prompt the user after reviewing the information related to financial transactions between the user and other parties and determining that the user most frequently engages in financial transactions with Merchant 1. The banking system 700 may use any method or process for determining whether or not prompt the user to determine if the user wants to make future P2P payments to Merchant 1.

Although at block 1015 the banking system 700 automatically prompts the user to determine if the user wants to make future P2P payments to Merchant 1, the banking system 700 may use any other type of prompt to determine the user's intention to store the alias identifier of Merchant 1. For instance, in some embodiments, the banking system 700 may prompt the user to determine if the user would like to store Merchant 1's alias identifier in a list of P2P recipients. In other embodiments, the banking system 700 may prompt the user to determine if the user would like to save the alias identifier of Merchant 1 for future use. As one of skill in the art will appreciate, there are infinite variations of the actual textual content of any prompt according to the invention. Additionally, the banking system 700 may use any means to prompt the user (such as pop up windows, audible signals, etc.) that would be known in the fields of website development, mobile application development, computer science, computer programming and the like.

At block 1020, the user indicates that the user would like to make future P2P payments to Merchant 1. The user may use any means to indicate a response to the prompt at block 1015, including but not limited to using computer hardware (e.g., keyboard, mouse, etc.), voice commands, or physical gestures (e.g., screen tapping, hand waving, etc.). In some embodiments of the invention, the user may indicate a response by using personal computing device 400. In other embodiments of the invention, the user may provide an affirmative response to whatever prompt is provided at block 1015 via any other means (e.g., dialing a phone number and provided an affirmative response via a phone, etc.).

While in the embodiment of the invention described in relation to process flow 1000 the user indicates that the user would like to make future P2P payments after being prompted at block 1015, in other embodiments of the invention, the user may make the indication at block 1020 without being prompted by the system. For instance, in some embodiments of the invention, the user may select a hyperlink or other selectable icon that is associated with Merchant 1. In some embodiments, this selectable icon would be accessible through the use of an online banking website, mobile banking application and/or mobile P2P payment application. In these embodiments, the user's selection of the hyperlink or icon serves as an indication that the user would like to make future P2P payments to Merchant 1.

Returning back to process flow 1000, at block 1025, the banking system 700 receives information associated with Merchant 1. In some embodiments, banking system 700 receives information associated with Merchant 1 from personal computing device 400 via network 350. In some other embodiments, banking system 700 receives information associated with Merchant 1 from an other financial institution banking system 370 via network 350.

In the embodiment of process flow 1000, the information associated with Merchant 1 is the user's affirmative response at block 1020 that the user would like to make future P2P payments to Merchant 1. However, in other embodiments, the information associated with Merchant 1 may be any amount or type of information associated with Merchant 1. In some embodiments, the information associated with a Merchant 1 is the name and/or address of Merchant 1. In other embodiments, the information associated with Merchant 1 may be a bank account number associated with Merchant 1. In yet some other embodiments, the information associated with Merchant 1 is an indication that a user has selected the name of Merchant 1 through a user interface.

At block 1030, the banking system 700 determines if Merchant 1 can receive future P2P payments from the user. In the embodiment of the invention at block 1030, the banking system 700 compares the name of Merchant 1 to stored information to determine if Merchant 1 can receive P2P payments from the user. Stored information may be any number and/or type of information that indicates that a party that can receive P2P payments from the user. In other embodiments of the invention, the banking system 700 may compare the information associated with Merchant 1, which the banking system 700 received at block 1025, to stored information to determine if Merchant 1 can receive P2P payments from the user. In other embodiments, of the invention, the banking system 700 may use any other type of method to determine if Merchant 1 can receive P2P payments from the user, such as comparing other data associated with Merchant 1 to stored data.

In some embodiments of the invention, the stored information is stored in memory device of alias data repository 800. In other embodiments of the invention, the stored data is stored in the banking system 700 and/or in the other financial institution banking system 370. In other embodiments, the stored information may be stored in the memory device of any apparatus that is connected to banking system 700 via network 350.

At block 1030, banking system 700 may use any method to determine if the name of Merchant 1 matches information stored in alias data repository 800, including but not limited to text recognition, OCR technology, pattern recognition technologies and/or any technology relating to the searching of data stored in a memory device. In the embodiment of block 1030, banking system 700 compares the name of Merchant 1 to stored information that is stored in alias data repository 800 to determine if there is a complete match. If there is a complete match, then the system determines that Merchant 1 can receive P2P payments from the user. In other embodiments of the invention, banking system 700 may only compare the name of Merchant 1 to stored information determine if there is a partial match to information stored in alias data repository 800. If there is a partial match of the name of Merchant 1 to information stored in data repository 800, then the system determines that Merchant 1 can receive P2P payments from the user.

In some embodiments of the invention where banking system 700 compares information associated with Merchant 1 or other data to stored information, banking system 700 may determine that there are more than one matches between the information associated with Merchant 1 or other data and the stored data. In these embodiments, the user is presented with multiple match candidates and the user is prompted to choose the appropriate match or input additional information. The multiple candidates may be presented to the user by any means. For instance, in one embodiment, the candidates are presented to the user as a list, where the “strongest” candidate is listed first based on reliability of the match.

At block 1035, if banking system 700 determines that Merchant 1 cannot receive P2P payments from the user then the process flow proceeds to block 1040, where banking system 700 sends a notification to Merchant 1 and/or the user. In some embodiments of the invention, banking system 700 may send the same notification to Merchant 1 and/or the user. In other embodiments, the banking system sends different notifications. In one embodiment, banking system 700 may send a notification to the user that the Merchant 1 cannot receive P2P payments from the user. In another embodiment, banking system 700 may send a notification to Merchant 1 explaining that the user had requested to be able to send P2P payments to Merchant 1, but Merchant 1 is not able to receive such payments. In some embodiments, the notification to Merchant 1 may also include information regarding steps Merchant 1 can take so that the user can sent P2P payments to Merchant 1 in the future. In some embodiments, the notification may request that Merchant 1 open an account with the financial institution associated with the user. In other embodiments, the notification may request that Merchant 1 set-up a preexisting account so that it is capable of receiving P2P payments from the user.

At block 1040, banking system 700 may use any method to send the notification to Merchant 1 and/or the user, and it may send the notification through any communication means. In the embodiment of the invention at block 1040, banking system 700 sends a notification to the user via personal computing device 400 and/or sends a notification to Merchant 1 via personal computing device 500. In some embodiments, the banking system 700 may send the notification via email or the notification may appear as a prompt from an online banking website, mobile banking application, or P2P payment application. In other embodiments, banking system 700 may send a SMS message (i.e., text message) or picture message (i.e., MMS message) to the user and/or Merchant 1. In other embodiments, banking system 700 may prompt a third party to call Merchant 1 and/or the user. In yet other embodiment, banking system 700 may prompt a third party to mail a letter or other piece of mail to Merchant 1 and/or the user.

Additionally, at block 1040, the banking system 700 may use any means to determine how to send the notification to Merchant 1 and/or the user. In some embodiments, banking system 700 may access information about the user stored in a memory device of banking system 700 to determine how to contact the user and/or Merchant 1 via email, physical mail, telephone, etc. Further, banking system 700 may access information about Merchant 1 and/or the user stored in alias depository 800 or other sources, such as third party website or directories, to determine how to contact Merchant 1 and/or the user via email, physical mail, telephone, etc. In other embodiments, banking system 700 may access information stored in other financial institution banking system 370 to determine how to contact Merchant 1 and/or the user.

Alternatively, if banking system 700 does determine that Merchant 1 can receive P2P payments from the user, then the process flow proceeds to block 1045. At block 1045, banking system 700 populates a list of payment recipients with Merchant l′s alias identifier. In some embodiments of the invention, the list of payment recipients is accessible to the user via personal computing device 400 through the use of an online banking website. In other embodiments of the invention, where personal computing device 400 is a mobile device 600, the list of payment recipients is accessible to the user through the use of a mobile banking application or P2P payment application. The list of payment recipients is a list of parties which are capable of receiving P2P payments from the user according to the methods of the present invention.

In the embodiment of the invention at block 1045, the list of payment recipients is populated with Merchant 1's alias identifier. However, in other embodiments of the invention, banking system 700 may populate the list of payment recipients with any other name, text, term, image or symbol that could represent the party's alias identifier. For example, in some embodiments, the system may enable the user to suggest a nickname for the party's alias identifier and that nickname would be populated in the list of payment recipients. In other embodiments, the user may use an image or picture to represent the alias identifier of Merchant 1. In such embodiments, by choosing the nickname, image, picture, etc., the user would be choosing the alias identifier that it represents. Additionally, in other embodiments of the invention, the user may subsequently edit text or image that represents the alias identifier or delete the alias identifier from the list of payment recipients.

At block 1045, the list of payment recipients appears as a pull-down, or drop-down menu within the functionality of an online banking website, mobile banking application, or P2P payment application that is accessible through the use of personal computing device 400. However, in other embodiments, the list of payment recipients may appear in any form. As one of skill in the art will appreciate, the list of payment recipients is not limited to a pull-down, or drop down menu, and it may comprise any element (regardless of whether it is interactive or not) that is used in computer programming, software design, website design, mobile application design, or the like. The list of payment recipients may also be used in conjunction with any other bank functionality that relates to the sending of P2P payments.

At block 1050, after populating a list of payment recipients with the alias identifier of Merchant 1, banking system 700 enables the user to customize future payments to Merchant 1. In some embodiments of block 1050, banking system 700 enables to choose the account from which the user would like to make payments to Merchant 1. In other embodiments, banking system 700 enables the user to schedule future payments to Merchant 1, on a one-time basis and/or on a recurring basis (i.e., weekly, monthly, etc.). In yet other embodiments, banking system 700 enables the user to choose how or if it would like to be notified of any future payments to Merchant 1. For instance, in some embodiments, the user may input an email address or other contact information, and banking system 700 will send an email to the user after each subsequent payment to Merchant 1 is complete. The customization that occurs at block 1050 may occur in numerous different ways. In one embodiment, banking system 700 may prompt the user to provide customization when the system populates a list of payment recipients with Merchant l′s payment identifier, as represented in block 1045. In other embodiments, banking system 700 may prompt the user to provide customization when the user subsequently accesses an online banking website, mobile banking application or P2P payment application through the use of personal computing device 400. In other embodiments, the user may initiate the customization by accessing certain functionality of online banking website, mobile banking application or P2P payment application.

Although not depicted in process flow 1000, block 1050 may also incorporate the step of allowing Merchant 1 to customize the receipt of P2P payments from the user. In some embodiments, Merchant 1 may specify the bank account to which all P2P payments from the user shall be deposited.

At block 1055, the user makes a P2P payment to Merchant 1 using the process of the present invention, for which some embodiments are described in greater detail in relation to FIGS. 1 and 2. In performing the process flow of FIG. 1, the user chooses Merchant 1 as the recipient of a P2P payment by accessing the populated list of payment recipients from block 1045. As described herein, the user may make the P2P payment in numerous ways. In one embodiment, the user may make the P2P payment via an online banking website. In other embodiments, the user may make the payment via a P2P payment application or mobile banking application.

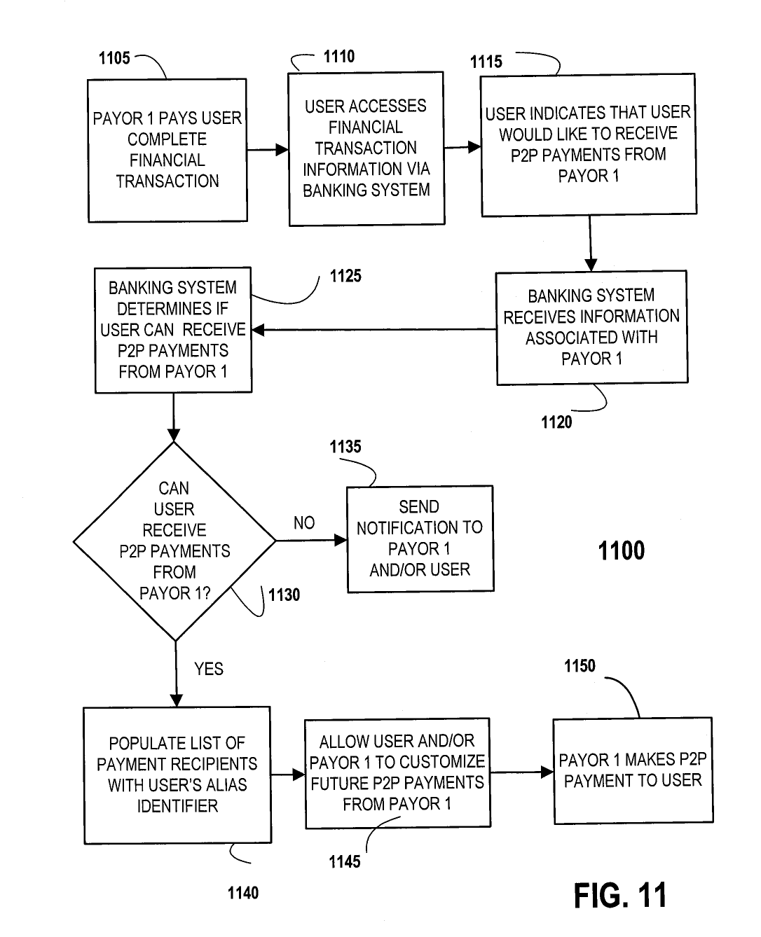

Referring now to FIG. 11, another more-detailed process flow 1100 for populating a list of P2P transaction participants, in accordance with an embodiment of the present invention is presented. Process flow 1100 represents another embodiment of process flow 900, however in this embodiment, the user engaged in a previous financial transaction with party (i.e., Payor 1) in which the user received a payment from the party (see block 1105).

In some embodiments, one or more portions of the process flow 1100 are performed by a system having hardware and/or software configured to perform one or more portions of the process flow 1100. In some of these embodiments, the system configured to perform the process flow 900 is also configured to perform the process flow 1100. As such, it will be understood that the process flow 1100 illustrated in FIG. 11 represents an example embodiment of the process flow 900 described in connection with FIG. 9.

As represented in block 1105, Payor 1 pays the user to complete a financial transaction between Payor 1 and the user. In this embodiment of the invention, the user provides goods to Payor 1 and Payor 1 pays user for the goods. However, with regards to process flow 1100, the financial transaction may be any one in which Payor 1 pays the user. Payor 1 may use any method for paying the user. In some embodiments, Payor 1 provides the user with a check. In other embodiments, Payor 1 uses a credit card or debit card to pay the user for the goods.

At block 1110, the user uses personal computing device 500 to access financial transaction information via a banking system 700. In some embodiments, the user accesses the banking system 700 online through the use of a bank website. In other embodiments, where personal computing device 500 is a mobile device 600, the user accesses the banking system 700 through the use of a mobile banking application stored on mobile device 600.

In the embodiment depicted in block 1110, the user accesses financial transaction information after Payor 1 has paid for the financial transaction of block 1105. As such, in this embodiment, when the user accesses financial transaction information, the user will see information related to the financial transaction between the user and Payor 1. The user may see any type of information related to the financial transaction between the user and Payor 1, including but not limited to: Payor 1's name, Payor 1's address, the date of the financial transaction between the user and Payor 1, the amount of the financial transaction between the user and Payor 1, any/or any other information relating the financial transaction, such as a check image, check number, or transaction number related to any payment via a credit card or debit card. In some embodiments, where the user conducts financial transactions with multiple third parties, the user may see information related to financial transactions between the user and other third parties (i.e., Payor 2, Payor 3, etc.)

At block 1115, the user indicates that the user would like to receive future P2P payments from Payor 1. The user may use any means to indicate at block 1115, including but not limited to using computer hardware (e.g., keyboard, mouse, etc.), voice commands, or physical gestures (e.g., screen tapping, hand waving, etc.). In some embodiments of the invention, the user may indicate a response by using personal computing device 500. For instance, in some embodiments of the invention, the user may select a hyperlink or other selectable icon that is associated with Payor 1. By selecting this hyperlink the user would be indicating that the user would like to receive P2P payments from Payor 1. In other embodiments of the invention, the user may select a hyperlink that enables to user to indicate that the user would like to receive P2P payments from all third parties (or a subset thereof) with whom the user had previously conducted a financial transaction. In the aforementioned embodiments, the hyperlink or selectable icon would be accessible through the use of an online banking website, mobile banking application and/or mobile P2P payment application. In these embodiments, the user's selection of the hyperlink or icon serves as an indication that the user would like to receive future P2P payments from Payor 1. In some other embodiments, the user indicates that the user would like to receive P2P payments from all third parties (or any subset of third parties with whom the user has entered into financial transactions).

In some embodiments of the invention, prior to indicating that the user would like to receive P2P payment from Payor 1, the user may receive a prompt seeking a determination of whether the user would like to receive P2P payments for Payor 1. In other embodiments, the user receives a prompt seeking a determination of whether the user would like to receive P2P payments from one or more of the other third parties with which the user has conducted financial transactions (i.e., Payor 2, Payor 3, etc.), which may or may not include Payor 1. In some embodiments of the invention, the system may prompt the user at block 1115 if banking system 700 reviews financial transaction information relating to the user and determines that the user has recently received a non-P2P payment from a third party, such as Payor 1. As one of skill in the art will appreciate, banking system 700 may prompt the user at block 1115 after making any type of analysis of the user's recent financial transactions.

Returning back to process flow 1100, at block 1120, the banking system 700 receives information associated with Payor 1. In some embodiments, banking system 700 receives information associated with Payor 1 from personal computing device 500 via network 350. In some embodiments, banking system 700 receives information associated with Payor 1 from an other financial institution banking system via network 350.

In the embodiment of process flow 1100, the information associated with Payor 1 is the user's affirmative indication at block 1115 that the user would like to receive future P2P payments from Payor 1. However, in other embodiments, the information associated with Payor 1 may be any amount or type of information associated with Payor 1. In some embodiments, the information associated with a Payor 1 is the name and/or address of Payor 1. In other embodiments, the information associated with Payor 1 may be a bank account number, credit card number, and/or debit card number associated with Payor 1. In yet some other embodiments, the information associated with Payor 1 is an indication that a user has selected a hyperlink or other selectable indicator associated with Payor 1.

At block 1125, the banking system 700 determines if the user can receive future P2P payments from Payor 1. In the embodiment of the invention at block 1125, the banking system 700 compares the name of Payor 1 to stored information to determine if the user can receive P2P payments from Payor 1. Stored information may be any number and/or type of information that indicates that the user can receive P2P payments from a third party. In other embodiments of the invention, the banking system 700 may compare the information associated with Payor 1, which the banking system 700 received at block 1120, to stored information to determine if the user can receive P2P payments from Payor 1. In other embodiments, of the invention, the banking system 700 may use any other type of method to determine if the user can receive P2P payments from Payor 1, such as comparing other data associated with Payor 1 to stored information.

In some embodiments of the invention, the stored information is stored in memory device of alias data repository 800. In other embodiments of the invention, the stored data is stored in the banking system 700 and/or in the other financial institution banking system 370. In other embodiments, the stored information may be stored in the memory device of any apparatus that is connected to banking system 700 via network 350.

At block 1125, banking system 700 may use any method to determine if the name of Payor 1 matches information stored in alias data repository 800, including but not limited to text recognition, OCR technology, pattern recognition technologies and/or any technology relating to the searching of data stored in a memory device. In the embodiment of block 1125, banking system 700 compares the name of Payor 1 to stored information that is stored in alias data repository 800 to determine if there is a complete match. If there is a complete match, then the system determines that user can receive P2P payments from Payor 1. In other embodiments of the invention, banking system 700 may only compare the name of Payor 1 to stored information determine if there is a partial match to information stored in alias data repository 800. If there is a partial match of the name of Payor 1 to information stored in data repository 800, then the system determines that user can receive P2P payments from Payor 1.

In some embodiments of the invention where banking system 700 compares information associated with Payor 1 or other data to stored information, banking system 700 may determine that there are more than one matches between the information associated with Payor 1 or other data and the stored data. In these embodiments, the user is presented with multiple match candidates and the user is prompted to choose the appropriate match or input additional information. The multiple candidates may be presented to the user by any means. For instance, in one embodiment, the candidates are presented to the user as a list, where the “strongest” candidate is listed first based on reliability of the match.

At block 1130, if banking system 700 determines that the user cannot receive P2P payments from Payor 1 then the process flow proceeds to block 1135, where banking system 700 sends a notification to Payor 1 and/or the user. In some embodiments of the invention, banking system 700 may send the same notification to Payor 1 and/or the user. In other embodiments, the banking system sends different notifications. In one embodiment, banking system 700 may send a notification to the user that the user cannot receive P2P payments from Payor 1. In another embodiment, banking system 700 may send a notification to Payor 1 explaining that the user had requested to be able to receive P2P payments from Payor 1, but the user is not able to receive such payments. In some embodiments, the notification to Payor 1 may also include information regarding steps Payor 1 can take so that Payor 1 can send P2P payments to user in the future. In some embodiments, the notification may request that Payor 1 open an account with the financial institution associated with the user. In other embodiments, the notification may request that Payor 1 set-up a preexisting account so that it is capable of sending P2P payments to the user.

At block 1135, banking system 700 may use any method to send the notification to Payor 1 and/or the user, and it may send the notification through any communication means. In the embodiment of the invention at block 1135, banking system 700 sends a notification to the user via personal computing device 500 and/or sends a notification to Payor 1 via personal computing device 400. In some embodiments, the banking system 700 may send the notification via email or the notification may appear as a prompt from an online banking website, mobile banking application, or P2P payment application. In other embodiments, banking system 700 may send a SMS message (i.e., text message) or picture message (i.e., MMS message) to the user and/or Payor 1. In other embodiments, banking system 700 may prompt a third party to call Payor 1 and/or the user. In yet other embodiment, banking system 700 may prompt a third party to mail a letter or other piece of mail to Payor 1 and/or the user.

Additionally, at block 1135, the banking system 700 may use any means to determine how to send the notification to Payor 1 and/or the user. In some embodiments, banking system 700 may access information about the user stored in a memory device of banking system 700 to determine how to contact the user and/or Payor 1 via email, physical mail, telephone, etc. Further, banking system 700 may access information about Payor 1 and/or the user stored in alias depository 800 or other sources, such as third party website or directories, to determine how to contact Payor 1 and/or the user via email, physical mail, telephone, etc. In other embodiments, banking system 700 may access information stored in other financial institution banking system 370 to determine how to contact Payor 1 and/or the user.

Alternatively, if banking system 700 does determine that the user can receive P2P payments from the Payor 1, then the process flow proceeds to block 1140. At block 1140, banking system 700 populates a list of payment recipients with the user's alias identifier. In some embodiments of the invention, the list of payment recipients is accessible to Payor 1 via personal computing device 400 through the use of an online banking website. In other embodiments of the invention, where personal computing device 400 is a mobile device 600, the list of payment recipients is accessible to Payor 1 through the use of a mobile banking application or P2P payment application. The list of payment recipients is a list of individuals or entities that are capable of receiving P2P payments from Payor 1 according to the methods of the present invention.

In some embodiments of the invention, the list of payment recipients is automatically populated with the user's alias identifier. In some of these embodiments, Payor 1 may receive a notification that the list of payment recipients has been updated with the user's alias. The notification to Payor 1 may occur through any means, including email, SMS message, MMS message, phone call, physical mail. Furthermore, in some embodiments, the notification may appear via an online banking website, mobile banking application or P2P payment application. Alternatively, the list of payment recipients may only updated with the alias identifier of the user if banking system 700 receives an indication from Payor 1. Payor 1 could provide this indication in any way, including without limitation via an online banking website, mobile banking application or P2P payment application.

In the embodiment of the invention at block 1140, the list of payment recipients is populated with the user's alias identifier. However, in other embodiments of the invention, banking system 700 may populate the list of payment recipients with any other name, text, term, image or symbol that could represent the user's alias identifier. For example, in some embodiments, the system may enable Payor 1 to suggest a nickname for the user's alias identifier and that nickname would be populated in the list of payment recipients. In other embodiments, Payor 1 may use an image or picture to represent the alias identifier of the user. In such embodiments, by choosing the nickname, image, picture, etc., Payor 1 would be choosing the alias identifier that it represents. Additionally, in other embodiments of the invention, Payor 1 may subsequently edit text or image that represents the alias identifier or delete the alias identifier from the list of payment recipients.

At block 1140, the list of payment recipients appears as a pull-down, or drop-down menu within the functionality of an online banking website, mobile banking application, or P2P payment application that is accessible through the use of personal computing device 400. However, in other embodiments, the list of payment recipients may appear in any form. As one of skill in the art will appreciate, the list of payment recipients is not limited to a pull-down, or drop down menu, and it may comprise any element (regardless of whether it is interactive or not) that is used in computer programming, software design, website design, mobile application design, or the like. The list of payment recipients may also be used in conjunction with any other bank functionality that relates to the sending of P2P payments.

At block 1145, after populating a list of payment recipients with the alias identifier of the user, banking system 700 enables the user and/or Payor 1 to customize future P2P payments. In some embodiments of block 1145, banking system 700 enables Payor 1 to choose the account from which the Payor 1 would like to make payments to the user. In other embodiments, banking system 700 enables the Payor 1 to schedule future payments to the user, on a one-time basis and/or on a recurring basis (i.e., weekly, monthly, etc.). In yet other embodiments, banking system 700 enables the Payor 1 to choose how or if it would like to be notified of any future payments to the user. For instance, in some embodiments, Payor 1 may input an email address or other contact information, and banking system 700 will send an email to Payor 1 after each subsequent payment to the user is complete. In yet other embodiments of the invention, banking system 700 may allow the user to indicate the bank account into which the user would like to receive future P2P payments from Payor 1.

The customization that occurs at block 1145 may occur in numerous different ways. In one embodiment, banking system 700 may prompt Payor 1 and/or the user to provide customization when the system populates a list of payment recipients with user's payment alias, as represented in block 1140. In other embodiments, banking system 700 may prompt the Payor 1 and/or the user to provide customization when the Payor 1 and/or the user subsequently access an online banking website, mobile banking application or P2P payment application. In other embodiments, the Payor 1 and/or the user may initiate the customization by accessing certain functionality of online banking website, mobile banking application or P2P payment application.

At block 1150, Payor 1 makes a P2P payment to the user using the process of the present invention, for which some embodiments are described in greater detail in relation to FIGS. 1 and 2. In performing the process flow of FIG. 1, Payor 1 chooses the user as the recipient of a P2P payment by accessing the populated list of payment recipients from block 1140. As described herein, the Payor 1 may make the P2P payment in numerous ways. In one embodiment, Payor 1 may make the P2P payment via an online banking website. In other embodiments, Payor 1 may make the payment via a P2P payment application or mobile banking application.

Although not discussed in relation to FIGS. 10-11, in other embodiments, the system and method of the present invention could be used to populate a list of third parties that a user is authorizing to send P2P payments to the user. For example, the system could review a user's financial transaction history to identify third parties with whom the user frequently conducts financial transactions. After receiving an indication from the user, the system could perform at least the steps of (1) determining that the user may receive P2P payments from any number of those third parties; (2) populate a list of authorized payment senders with each third party's alias; (3) and allow the user to customize the subsequent receipt of P2P payments from each of the authorized payment senders. For example, in some embodiments, the user could specific the bank accounts to which all P2P payments from authorized senders should be directed.

As will be appreciated by one of ordinary skill in the art in view of this disclosure, the present invention may include and/or be embodied as an apparatus (including, for example, a system, machine, device, computer program product, and/or the like), as a method (including, for example, a business method, computer-implemented process, and/or the like), or as any combination of the foregoing. Accordingly, embodiments of the present invention may take the form of an entirely business method embodiment, an entirely software embodiment (including firmware, resident software, micro-code, etc.), an entirely hardware embodiment, or an embodiment combining business method, software, and hardware aspects that may generally be referred to herein as a “system.” Furthermore, embodiments of the present invention may take the form of a computer program product that includes a computer-readable storage medium having one or more computer-executable program code portions stored therein. As used herein, a processor, which may include one or more processors, may be “configured to” perform a certain function in a variety of ways, including, for example, by having one or more general-purpose circuits perform the function by executing one or more computer-executable program code portions embodied in a computer-readable medium, and/or by having one or more application-specific circuits perform the function.

It will be understood that any suitable computer-readable medium may be utilized. The computer-readable medium may include, but is not limited to, a non-transitory computer-readable medium, such as a tangible electronic, magnetic, optical, electromagnetic, infrared, and/or semiconductor system, device, and/or other apparatus. For example, in some embodiments, the non-transitory computer-readable medium includes a tangible medium such as a portable computer diskette, a hard disk, a random access memory (RAM), a read-only memory (ROM), an erasable programmable read-only memory (EPROM or Flash memory), a compact disc read-only memory (CD-ROM), and/or some other tangible optical and/or magnetic storage device. In other embodiments of the present invention, however, the computer-readable medium may be transitory, such as, for example, a propagation signal including computer-executable program code portions embodied therein.

One or more computer-executable program code portions for carrying out operations of the present invention may include object-oriented, scripted, and/or unscripted programming languages, such as, for example, Java, Perl, Smalltalk, C++, SAS, SQL, Python, Objective C, and/or the like. In some embodiments, the one or more computer-executable program code portions for carrying out operations of embodiments of the present invention are written in conventional procedural programming languages, such as the “C” programming languages and/or similar programming languages. The computer program code may alternatively or additionally be written in one or more multi-paradigm programming languages, such as, for example, F#.

Some embodiments of the present invention are described herein with reference to flowchart illustrations and/or block diagrams of apparatuses and/or methods. It will be understood that each block included in the flowchart illustrations and/or block diagrams, and/or combinations of blocks included in the flowchart illustrations and/or block diagrams, may be implemented by one or more computer-executable program code portions. These one or more computer-executable program code portions may be provided to a processor of a general purpose computer, special purpose computer, and/or some other programmable data processing apparatus in order to produce a particular machine, such that the one or more computer-executable program code portions, which execute via the processor of the computer and/or other programmable data processing apparatus, create mechanisms for implementing the steps and/or functions represented by the flowchart(s) and/or block diagram block(s).

The one or more computer-executable program code portions may be stored in a transitory and/or non-transitory computer-readable medium (e.g., a memory, etc.) that can direct, instruct, and/or cause a computer and/or other programmable data processing apparatus to function in a particular manner, such that the computer-executable program code portions stored in the computer-readable medium produce an article of manufacture including instruction mechanisms which implement the steps and/or functions specified in the flowchart(s) and/or block diagram block(s)

The one or more computer-executable program code portions may also be loaded onto a computer and/or other programmable data processing apparatus to cause a series of operational steps to be performed on the computer and/or other programmable apparatus. In some embodiments, this produces a computer-implemented process such that the one or more computer-executable program code portions which execute on the computer and/or other programmable apparatus provide operational steps to implement the steps specified in the flowchart(s) and/or the functions specified in the block diagram block(s). Alternatively, computer-implemented steps may be combined with, and/or replaced with, operator- and/or human-implemented steps in order to carry out an embodiment of the present invention.

While certain exemplary embodiments have been described and shown in the accompanying drawings, it is to be understood that such embodiments are merely illustrative of and not restrictive on the broad invention, and that this invention not be limited to the specific constructions and arrangements shown and described, since various other changes, combinations, omissions, modifications and substitutions, in addition to those set forth in the above paragraphs, are possible. Those skilled in the art will appreciate that various adaptations, modifications, and combinations of the just described embodiments can be configured without departing from the scope and spirit of the invention. Therefore, it is to be understood that, within the scope of the appended claims, the invention may be practiced other than as specifically described herein.

What is claimed is:

1. A method implemented by a computing device, wherein the computing device allows a user to populate a list of user-to-user “U2U” transaction participants, the method comprising:
receiving information associated with a party to a financial transaction with the user;
determining, based at least partially on the information, that the party can participate in a U2U transaction with the user; and
populating the list of U2U transaction participants with an alias identifier.

2. The method of claim 1, wherein receiving information associated with a party to a financial transaction with the user comprises receiving the name of the party.

3. The method of claim 1, wherein receiving information associated with a party to a financial transaction with the user comprises receiving an indication that the user would like to make a U2U payment to the party.

4. The method of claim 1, wherein receiving information associated with a party to a financial transaction with the user comprises receiving an indication that the user would like to receive a U2U payment from the party.

5. The method of claim 1, wherein determining, based at least partially on the information associated with the party, that the party can participate in a U2U transaction with the user comprises comparing the party's name to information about parties that can participate in a U2U transaction with the user.

6. The method of claim 1, wherein populating a list of U2U transaction participants with an alias identifier comprises populating a list of U2U payment recipients with an alias identifier.

7. The method of claim 6, wherein populating the list of U2U payment recipients with the alias identifier comprises populating the list of U2U payment recipients with the alias identifier of the party.

8. The method of claim 6, populating the list of U2U payment recipients with the alias identifier comprises populating the list of U2U payment recipients with the alias identifier of the user.

9. The method of claim 1, wherein populating a list of U2U transaction participants with an alias identifier comprises populating a list of authorized U2U payment senders with the alias identifier of the party.

10. The method of claim 1, wherein receiving information associated with a party to a financial transaction with a user comprises receiving the information at a computing device associated with the user.

11. The method of claim 10, wherein receiving the information at the computing device associated with the user comprises receiving the information at a mobile device.

12. The method of claim 1, wherein receiving information associated with a party to a financial transaction with a user comprises receiving the information at a network device in communication with a computing device associated with the user.

13. The method of claim 1, wherein determining, based at least partially on the information associated with the party, that the party can participate in a U2U transaction with the user comprises making the determination at a computing device associated with the user.

14. The method of claim 1, wherein determining, based at least partially on the information associated with the party, that the party can participate in a U2U transaction with the user comprises making the determination at a network device in communication with a computing device associated with the user.

15. The method of claim 1, wherein populating a list of U2U transaction participants with an alias identifier comprises populating a list of U2U transaction participants that is accessible to the user.

16. The method of claim 1, wherein populating a list of U2U transaction participants with an alias identifier comprises populating a list of U2U transaction participants that is accessible to the party.

17. An apparatus configured to allow a user to populate a list of user-to-user (“U2U”) transaction participants, the apparatus comprising:
a communication device; and
a processing device communicably coupled to the communication device, wherein the processing device is configured to:
receive information associated with a party to a financial transaction with the user;
determine, based at least partially on the information, that the party can participate in a U2U transaction with the user; and
populate the list of U2U transaction participants with an alias identifier.

18. The apparatus of claim 17, wherein the information associated with a party to a financial transaction with the user comprises the name of the party.

19. The apparatus of claim 17, wherein the information associated with a party to a financial transaction with the user comprises an indication that the user would like to make a U2U payment to the party.

20. The apparatus of claim 17, wherein the information associated with a party to a financial transaction with the user comprises an indication that the user would like to receive a U2U payment from the party.

21. The apparatus of claim 17, wherein the apparatus determines, based at least partially on the information associated with the party, that the party can participate in a U2U transaction with the user by comparing the party's name to information about parties that can participate in a U2U transaction with the user.

22. The apparatus of claim 17, wherein the list of U2U transaction participants comprises a list of U2U payment recipients.

23. The apparatus of claim 22, wherein the alias identifier comprises the alias identifier of the party.

24. The apparatus of claim 22, wherein the alias identifier comprises the alias identifier of the user.

25. The apparatus of claim 17, wherein the list of U2U transaction participants comprises a list of authorized U2U payment senders and the alias identifier comprises the alias identifier of the party.

26. The apparatus of claim 17, wherein the apparatus is a computing device associated with the user.

27. The apparatus of claim 26, wherein the computing device associated with the user is a mobile device.

28. The apparatus of claim 17, wherein the apparatus is a network device in communication with a computing device associated with the user.

29. The method of claim 17, wherein the list of U2U transaction participants is accessible to the user.

30. The method of claim 17, wherein the list of U2U transaction participants is accessible to the party.

31. A computer program product for allowing a user to populate a list of user-to-user (“U2U”) transaction participants, the computer program product comprising computer executable program code that, when executed by a computing device, causes the computing device to:
receive information associated with a party to a financial transaction with the user;
determine, based at least partially on the information, that the party can participate in a U2U transaction with the user; and
populate the list of U2U transaction participants with an alias identifier.

32. The computer program product of claim 31, wherein the computer executable program code that causes the computing device to receive information associated with a party to a financial transaction with the user comprises computer executable program code that causes the computing device to receive the name of the party.

33. The computer program product of claim 31, wherein the computer executable program code that causes the computing device to receive information associated with a party to a financial transaction with the user comprises computer executable program code that causes the computing device to receive an indication that the user would like to make a U2U payment to the party.

34. The computer program product of claim 31, wherein the computer executable program code that causes the computing device to receive information associated with a party to a financial transaction with the user comprises computer executable program code that causes the computing device to receive an indication that the user would like to receive a U2U payment from the party.

35. The computer program product of claim 31, wherein the computer executable program code that causes the computing device to determine, based at least partially on the information associated with the party, that the party can participate in a U2U transaction with the user comprises computer executable program code that causes the computing device to compare the party's name to information about parties that can participate in a U2U transaction with the user.

36. The computer program product of claim 31, wherein the computer executable program code that causes the computing device to populate a list of U2U transaction participants with an alias identifier comprises computer executable program code that causes the computing device to populate a list of U2U payment recipients with an alias identifier.

37. The computer program product of claim 36, wherein the computer executable program code that causes the computing device to populate the list of U2U payment recipients with the alias identifier comprises computer executable program code that causes the computing device to populate the list of U2U payment recipients with the alias identifier of the party.

38. The computer program product of claim 36, wherein the computer executable program code that causes the computing device to populate the list of U2U payment recipients with the alias identifier comprises computer executable program code that causes the computing device to populate the list of U2U payment recipients with the alias identifier of the user.

39. The computer program product of claim 31, wherein the computer executable program code that causes the computing device to populate a list of U2U transaction participants with an alias identifier comprises computer executable program code that causes the computing device to populate a list of authorized U2U payment senders with the alias identifier of the party.

40. The computer program product of claim 31, wherein the computer executable program code that causes the computing device to receive information associated with a party to a financial transaction with a user comprises computer executable program code that causes the computing device to receive the information at a computing device associated with the user.

41. The computer program product of claim 40, wherein the computer executable program code that causes the computing device to receive the information at the computing device associated with the user comprises computer executable program code that causes the computing device to receiving the information at a mobile device.

42. The computer program product of claim 31, wherein the computer executable program code that causes the computing device to receive information associated with a party to a financial transaction with a user comprises computer executable program code that causes the computing device to receive the information at a network device in communication with a computing device associated with the user.

43. The computer program product of claim 31, wherein the computer executable program code that causes the computing device to determine, based at least partially on the information associated with the party, that the party can participate in a U2U transaction with the user comprises computer executable program code that causes the computing device to make the determination at a computing device associated with the user.

44. The computer program product of claim 31, wherein the computer executable program code that causes the computing device to determine, based at least partially on the information associated with the party, that the party can participate in a U2U transaction with the user comprises the computer executable program code that causes the computing device to determine based at least partially on the information associated with the party, that the party can participate in a U2U transaction with the user at a network device in communication with a computing device associated with the user.

45. The computer program product of claim 31, wherein the computer executable program code that causes the computing device to populate a list of U2U transaction participants with an alias identifier comprises the computer executable program code that causes the computing device to populate a list of U2U transaction participants that is accessible to the user.

46. The computer program product of claim 31, wherein the computer executable program code that causes the computing device to populate a list of U2U transaction participants with an alias identifier comprises computer executable program code that causes the computing device to populate a list of U2U transaction participants that is accessible to the party.
